(19) United States
(12) Patent Application Publication
(10) Pub. No.: US 2014/0297427 A1
(43) Pub. Date: Oct. 2, 2014

(54) Method of online national and local text, banner and video advertisement self-creation

(71) Applicant: Qiuhang Richard Qian, Marble Falls, TX (US)

(72) Inventor: Qiuhang Richard Qian, Marble Falls, TX (US)

(21) Appl. No.: 14/120,599

(22) Filed: Jun. 9, 2014

(51) Int. Cl. G06Q 30/02

(52) U.S. Cl. CPC G06Q 30/0276; G06Q 30/0275
USPC 705/14.71; 705/14.69

(57) ABSTRACT

The present invention relates to online national and local text, banner and video advertisement self-creation. The method is developed for the business to design and post either text, banner or video at the level which the business choose. There nine different levels. The business follow the created steps which include logging on to the internet, assessing the service provider's website, creating an account, selecting a level, selecting advertisement format, choosing an advertisement location or a service, designing text, banner or video advertisement, uploading advertisement content, choosing posting period, previewing the created advertisement, making online payment, and submitting. The present invention is web-based. It is built by Java. The compiled programs enable the user to access the web server application, create and manage advertisement by themselves. They are logically related set of language statements that perform a specific task. The programs are called by triggering. They include procedures, functions and packages, and are stored in the data dictionary.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to online advertisement self-creation. More particularly, the present invention relates to creating a method for the business to design and post text, banner or video advertisement nationally and locally by using the online tools. The business can design and post either text, banner or video commercial advertisement at the national and local level by themselves. They can select any advertisement location on the web pages or any service at any level. The web application consists of nine different levels as shown below:

| Level | Description |
|---|---|
| Level 1 | The national level |
| Level 2 | The state level |
| Level 3 | The metro area level |
| Level 4 | The city level |
| Level 5 | The business listing level |
| Level 6 | The industrial national level |
| Level 7 | The first industrial level |
| Level 8 | The second industrial level |
| Level 9 | The industrial business listing level |

Internet was invented decades ago. However, online commercial text, banner and video advertisement nationalization and localization self-created and operated method is new. The method is developed for the business for marketing purpose. No similar patents have been created before. As is known most business would like to advertise through newspaper, TV and radio. These traditional methods target different consumer groups. With the growth of the Internet, more and more business would like to use the internet as another way of marketing because of its advantages such as cost. However, not every website is suitable for all the business, due to the different reasons. At present there is no company that can provide an easy and efficient way for the business to do online marketing at the national and local level, especially for the medium and small companies at the local level.

The online advertisement self-creation method is developed by computer language. The application is stored on the server. It is supported by Unix, MS OS, network equipment and databases. The programs are compiled procedures, packages and functions that are stored on the server and run when events are triggered. The programs help the business get their desired results. The Unix and MS OS are operating systems that contain operating commands. When the commands are initiated, the background process will run. The network equipment provides the bridge between the internet, computers and servers. The databases are the database files that record the data on the server that can be updated. The business access the web application through internet by the operating system. The business can design, create, post and manage advertisement by themselves. The advertisement is saved and shown on the web page after it is created.

Web technology has been largely used in different industries for a long time. The present invention provides a gateway communication between the business and web application on the server. The business use the developed services. The website service company registers the web domain. The application is developed by java. The host service provider provides the service to present the website for the business. The internet service provider issues the link which is called the IP address with equipment if necessary. The IP address can be dedicated statically or randomly assigned. The business access the internet and the website. The system consists of computers and server machines. There are different kinds of servers that are used for hosting the websites. Computers are used for data operation and manipulation. The developed programs and application are installed on the memory device in the computing system. When the business log on to internet and access the service provider's website, the IP address is released.

### BRIEF SUMMARY OF THE INVENTION

The present invention relates to online national and local commercial text, banner, and video advertisement self-creation method for the business. The business use and follow the developed process steps and online tools to design, create and post advertisement. The method is built to help the business do online advertising and marketing. The present invention consists of commercial and industrial modules with nine levels. The business is required to create an account before they can design, create and post advertisement. They need to follow the steps to finish posting the advertisement at the level they choose. These steps include 1). Creating an account, 2). Selecting a module, 3). Choosing a level and advertisement format, 4). Choosing a web page location or selecting a service, 5). Using design tools, 6). Creating content, 7). Previewing, 8). Modifying, 9). Making payment online, 10). Saving and launching, 11). Notifying, and 12). Renewing or closing. The present invention is developed by java. The application is stored on the server. The programs are functional procedures and packages. They will be invoked when the events are triggered. The events are built for different purposes. The created advertisement will be shown on the webpage after the business complete the steps. The business can operate and update their advertisement content in their account online anytime.

### BRIEF DESCRIPTION OF THE DRAWINGS

FIG. 1 is a process flow diagram illustrating how text advertisement is developed in module 1 and 2.

FIG. 2 (a) is a process flow diagram illustrating how banner and video advertisement is developed at the first level in Module 1.

FIG. 2 (b) is a process flow diagram illustrating how banner and video advertisement is developed at the first level in Module 1.

FIG. 2 (c) is a process flow diagram illustrating how banner and video advertisement is developed at the first level in Module 1.

FIG. 3 is a process flow diagram illustrating how banner and video advertisement is developed at the second level in Module 1.

FIG. 4 (a) is a process flow diagram illustrating how banner and video advertisement is developed at the third level in Module 1.

FIG. 4 (b) is a process flow diagram illustrating how banner and video advertisement is developed at the third level in Module 1.

FIG. 5 is a process flow diagram illustrating how banner and video advertisement is developed at the fourth level in Module 1.

FIG. 6 is a process flow diagram illustrating how banner and video advertisement is developed at the fifth level in Module 1.

FIG. 7 (a) is a process flow diagram illustrating how banner and video advertisement is developed at the sixth level in Module 2.

FIG. 7 (b) is a process flow diagram illustrating how banner and video advertisement is developed at the sixth level in Module 2.

FIG. 7 (c) is a process flow diagram illustrating how banner and video advertisement is developed at the sixth level in Module 2.

FIG. 8 is a process flow diagram illustrating how banner and video advertisement is developed at the seventh level in Module 2.

FIG. 9 is a process flow diagram illustrating how banner and video advertisement is developed at the eighth level in Module 2.

FIG. 10 is a process flow diagram illustrating how banner and video advertisement is developed at the ninth level in Module 2.

FIG. 11 is a process flow diagram illustrating how reservation of advertisement location is developed.

FIG. 12 is a process flow diagram illustrating how bid for advertisement location is developed.

FIG. 13 is a process flow diagram illustrating how auction of advertisement location is developed.

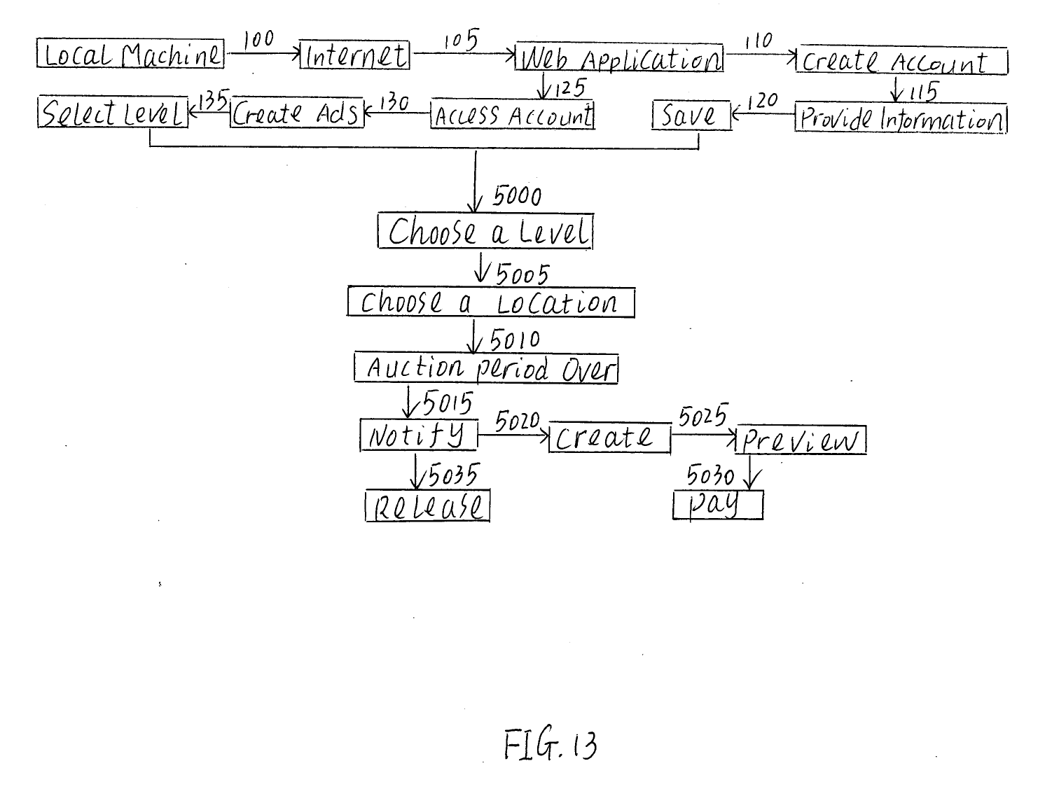

### DETAILED DESCRIPTION OF THE INVENTION

The present invention is created for the business to design, create and post advertisement nationally and locally by themselves. The preferred embodiment is generally described in the context of web application, programs, databases and operating systems that run on the server and personal computer. Furthermore, those skilled in the art will recognize that the present invention can be implemented in different network environments. For example, in a two-tier network, a business communicates directly with the server. This is known as client-server architecture. The client-server architecture involves the user process which requests the service from the server process. The user and server communicate over a network using a given protocol, which needs to be installed on both the user and the server. In an N-tier architecture, the middle-tier agent provides translation services (as in adapting a legacy application on a mainframe to a client-server environment or acting as a bridge between protocols), scalability services (as in acting as a transaction-processing monitor to balance the load of the requests between the servers), and intelligent agent services (as in mapping a request to a number of different servers, collating the results, and returning a single response to a user). In a complex network environment, different hardware platforms run different operating systems. Multiple protocols are used on these platforms. Variable syntax exist between the different but connected applications, and run on different geographical locations in which the connected applications reside.

In a distributed computing environment, program modules are physically located in different local and remote memory storage devices. Execution of the program modules occur locally in a stand-alone manner or remotely in a client server manner. Examples of such distributed computing environments include local area networks of an office, enterprise-wide computer networks and the global internet.

The detailed description which follows is represented largely in terms of programs, processes and symbolic representations of operations by computer and server components, including central processing unit (CPU), memory storage devices, display devices, and input devices. Furthermore, these processes and operations may utilize computer and server components in a heterogeneous distributed computing environment, including the remote file servers, remote computer servers, and remote memory storage devices. These distributed computing and server components are accessible by the CPU via communication network. The programs, processes and operations performed by the computer and server include the manipulation of signals by CPU or remote server and the maintenance of these signals within the data structures resident in one or more of the local or remote memory storage devices.

A program is generally conceived to be a sequence of computer and server executed steps leading toward a desired result. A program is a computer language compiled as a procedure or package stored on the computer and server. A process is also generally conceived to be a sequence of computer-executed steps leading to a desired result. These steps usually require physical manipulation of physical quantities such as access, authenticate, create, add, change, modify, save, calculate, compare, move, receive, determine, identify, populate, load and execute. The architecture contains computers, servers and the web application. The computer refers to the stand-alone local computer with operating system. The server refers to the computing hardware and network components with operating system. The web application refers to the programs developed for the business to use. The computer and server system are operated within the network and internet. It should be understood that the programs, processes and methods described herein are not related or limited to any particular computers or servers. Refer now to the drawings:

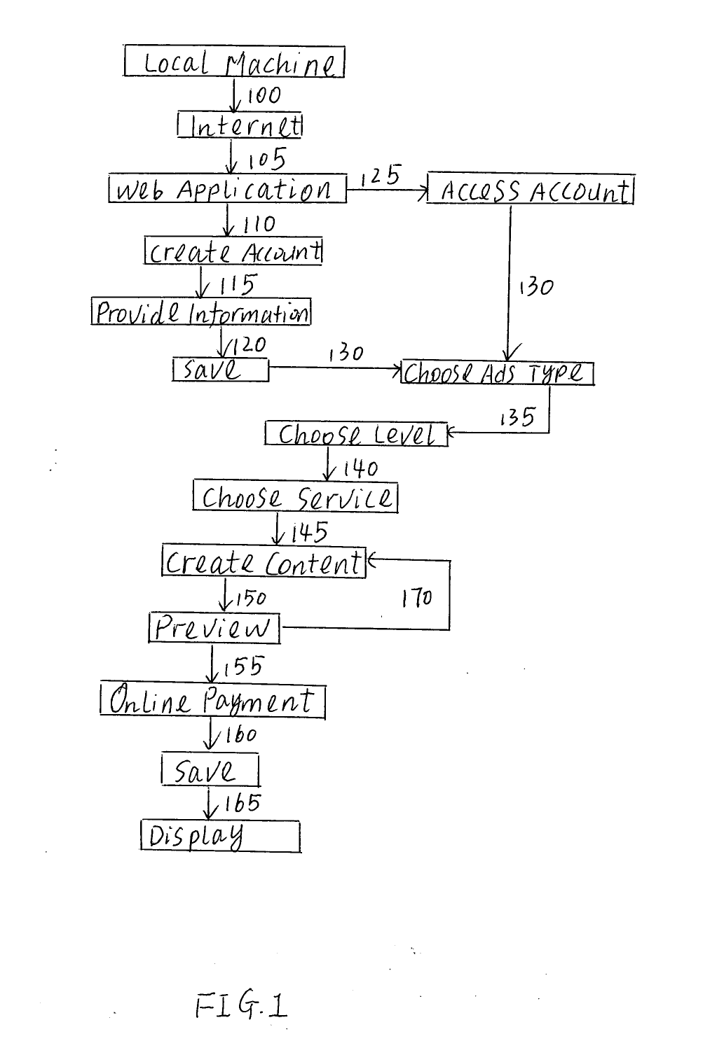

FIG. 1 is a functional block diagram illustrating how text advertisement is developed for the business to use in Module 1 and Module 2. The business connect to the web server through the internet (Step 100). The connection is a communication pathway between the user and the server process. A process created on the client's side is called the user process. The user originates the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page consists of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide the information (Step 115). The information includes business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). The next step is choosing a level (Step 130). The business need to choose a level. There are five levels in Module 1. The first level is national level. The second level is state level. The third level is metro area level. The fourth level is city level. And the fifth level is business listing level. After a level is selected, Step 135 is choosing a service category. Service categories are created for the business so that they can choose which category fits their text advertisement content. There are different text advertisement categories including on sale and clearance etc. When a service category is selected, the text advertisement creation page appears on the screen. The text advertisement creation page consists of a block area to type text advertisement. There are other functions on the text advertisement creation page which includes editing tools, advertising period, and functional buttons for previewing, modifying and submitting. Step 140 is creating text advertisement. The text advertisement needs to be previewed before submitting (Step 145). If the text advertisement looks fine, the business move to the next step. The next step is making online payment (Step 150). After the payment, the text advertisement will be saved on the server and displayed on the webpage scrolling from the right to the left (Step 155 and 160). If the text advertisement doesn't look fine, the process needs to go back and the business need to modify until the text advertisement looks fine (Step 165).

In the development of text advertisement module, the process flow first is decided. Pages' graphic layout and buttons need to be designed and created next. The third step is programming by using development tools. The text self-creation module needs to be tested. If the test is successful, it will be launched and saved on the server. The text self-creation method is developed by java. Java is a language used for compiling programs which are stored program units. They enable the user to access the website and manipulate procedural schema objects. Stored program units can be procedures, functions, triggers, or packages, and are created and stored in the data dictionary. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package. B). The body implements the specification. It includes the compiled codes to implement the procedure and function specification included in the package specification. It may also include procedures and functions that are callable only from inside of the package. The functionality of a package is similar to that of stored procedures.

The generated text advertisement is saved in the database. The purpose of database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

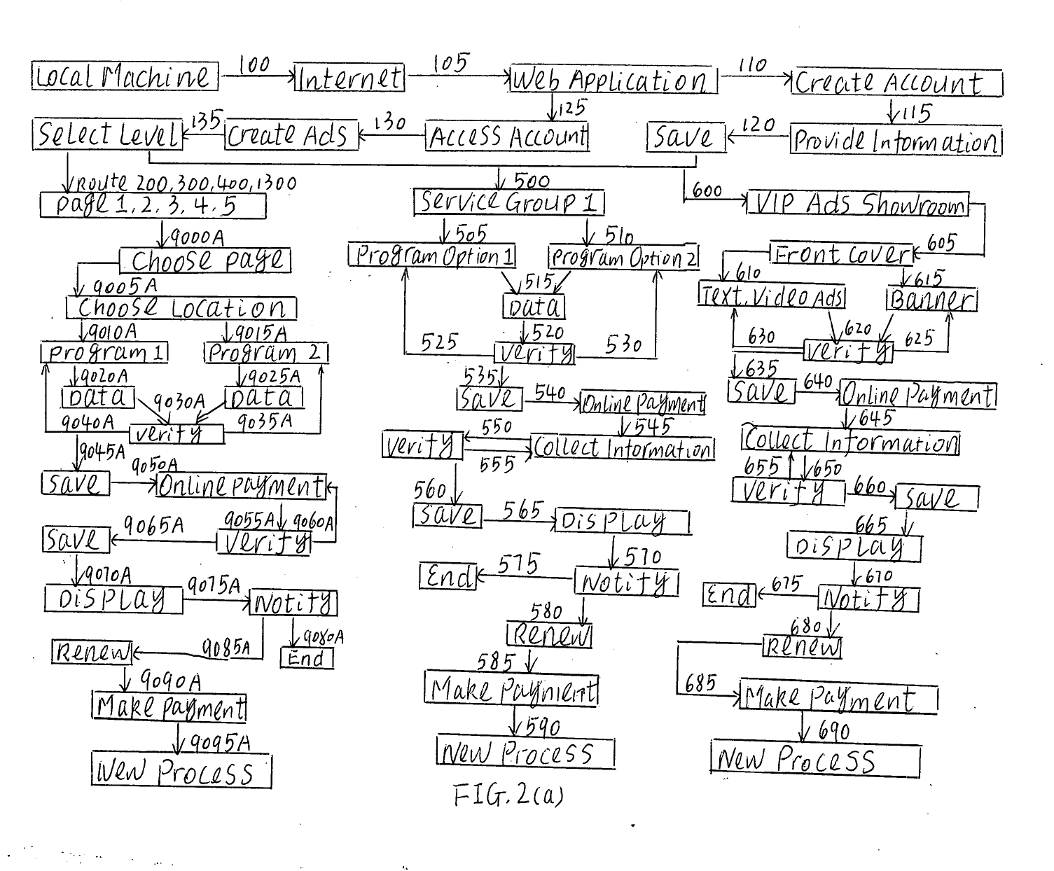

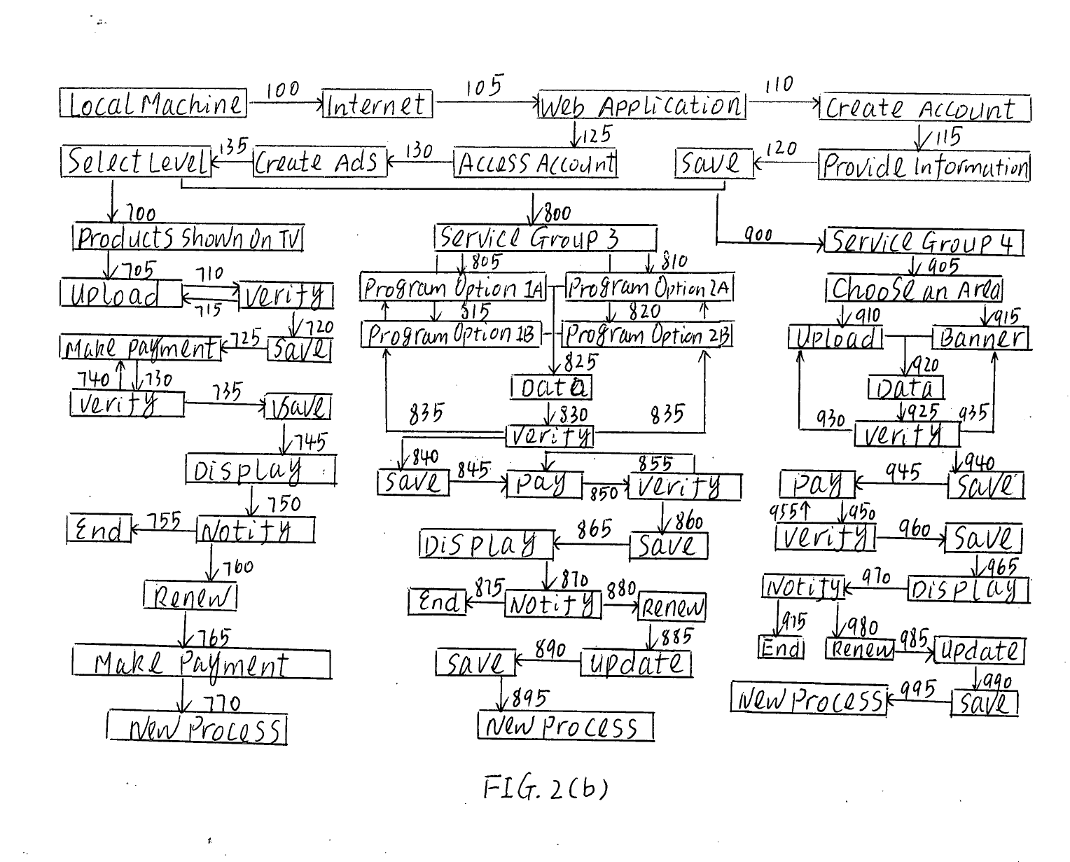

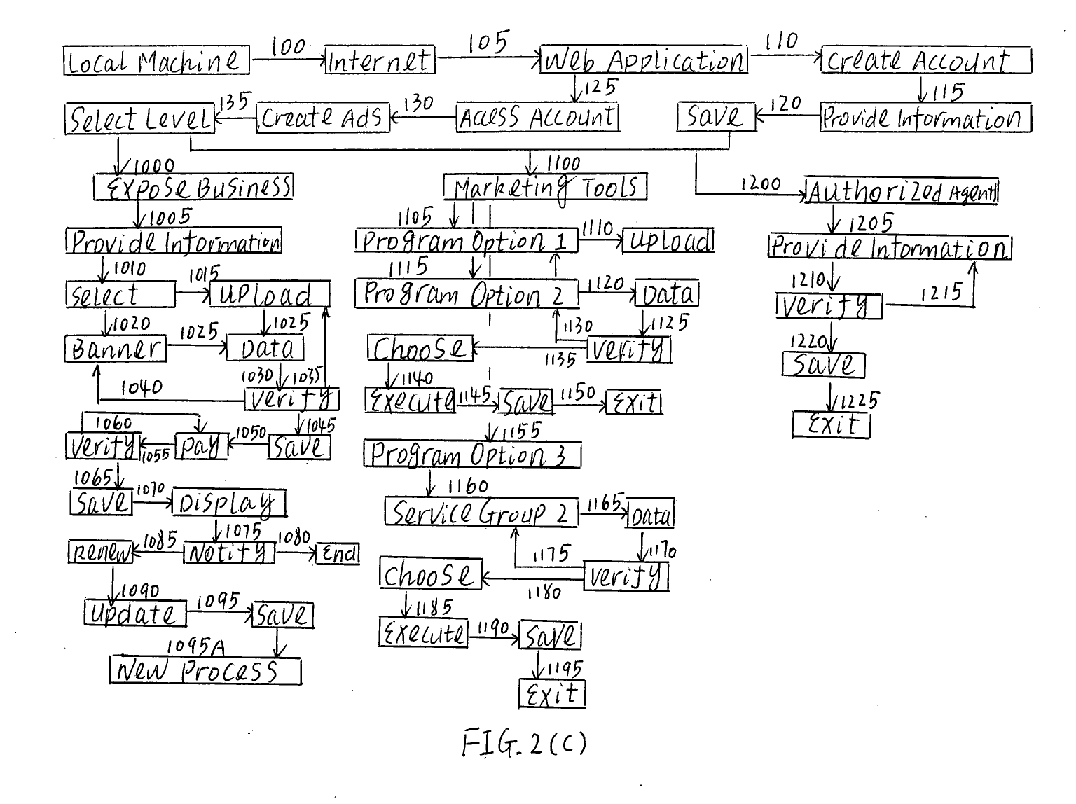

FIG. 2 (a) is a process flow diagram illustrating how advertisement self-creation is developed at the first level. The first level is also the national level. The first level consists of different web pages. Among the web pages there are different services that are built on them. One of the services is the banner and video advertisement spot locations that are created on each web page. Other service groups are built at the first level as well. The business can choose different services on different pages and create advertisement by themselves.

The business connect to the web server through the internet (Step 100). The connection is a communication pathway between the user and server process. A process created on the client's side is called user process. The user originates the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page consists of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information is includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the national level (Step 135).

Route 200, 300, 400 and 1300 lead the business to page 1, 2, 3, 4 and 5 at the first level. The routes are built for the business to design, create and post banner and video advertisement on these pages at the first level. The pages have advertisement locations. The locations are developed blocks for creating banner or video advertisement. The pages will pop up on the screen when the first level is selected. Step 9000A is choosing a page. The next step is choosing an advertising location (Step 9005A).

The business have the option to take Step 9010A (Program Option 1) or Step 9015A (Program Option 2). Step 9015A has more steps before getting the result. Step 9010A has fewer. The result refers to creating and posting the advertisement successfully. Step 9015A contains the tools and programs developed for the business to create banner advertisement. The tools include custom designed advertising templates, background colors, patterns, canvas and editor. The programs are stored units. They help the business finish creating the advertisement. In Step 9015A the business pick a template, choose background color from the galleries, select a canvas and a pattern, and use the editor to create the banner advertisement. The business follow each step before the banner advertisement is successfully created (Step 9025A).

If the business choose to go through Step 9010A, Program Option 1 initiates the process. Program Option 1 is developed for creating and posting video advertisement. If the video advertisement is pre-produced, the process sends the query on the local machine. If the query is successful, it returns the file data as result. There are three main stages in the process A). In parse, the request is passed from the user process, and a parsed representation of the request is loaded into the local computer. During the parse, the server process searches for the existing request copy of the request on the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done. The server usually translates each requirement, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 9020A).

The generated data from Step 9020A and Step 9025A needs to be verified (Step 9030A). If the data is not valid, the process goes back to Step 9010A or Step 9015A until the valid data is provided (Step 9035A and 9040A). If the data is valid, the server records the data and writes it to the data blocks in the database from database buffer cache (Step 9045A). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next is making payment online (Step 9050A). Payment information needs to be collected in this step. After the information is collected, it needs to be verified (Step 9055A). The verification includes the company or personal information such as the company or personal name, company address, credit card number, expiration date, security code, bank Route number and account number. If the data is invalid, the process takes Step 9060A and goes back to Step 9055A until the valid data is provided. If the data is valid, it will be submitted and saved in the database (Step 9065A), and the result will be displayed (Step 9070A). The result refers to the successful creating and posting either the banner or video advertisement on the page selected by the business at the first level.

Step 9075A is a program compiled to notify the business to renew the service when the advertisement is about to expire. The business have two options. The first option is ignoring it, and the advertisement will be taken off automatically (Step 9080A). The second option is renewing (Step 9085A). The business make the payment online before any data will be saved in the database on the server (Step 9090A). A new process will begin when the advertisement continues (Step 9095A).

Banner and advertisement self-creation method on the web pages at the national level is developed by Java. Java is a language used for compiling programs which are stored program units. They enable the user to access website and manipulate procedural schema objects. Stored program units are logically related set of language statements that perform a specific task. They can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub-programs available for use outside of the package. B). The body implements the specification. It includes the compiled codes to implement the procedure and function specification included in the package specification. It may also include procedures and functions that are callable only from inside of the package. The functionality of a package is similar to that of stored procedures.

Route 500 leads to Service Group 1 at the first level after the business access their account. Service Group 1 includes On Sale, Special Deals, Clearance, Closeouts, Overstocks, Liquidation Sales, National Tent Events, New & Unique Products, Quality Products, Hot Products, Products & Services Promotion, Business Opportunities, Finance-Investment, Franchises, Events, Trade Shows-Conventions, Workshops-Seminars, Auctions, and Announcements.

The business choose Program Option 1 (Step 505). Program Option 1 relates to uploading the banner or video advertisement from the local machine. The business initiate the request on the client's side. The server process starts the query. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the user to create the video advertisement by using the production tools and templates which include the steps to produce, edit, preview and post.

If the business select Program Option 2 (Step 510), they create image advertisement by using the online design tools. The design tools include the templates, background colors, patterns, editor and canvas. Step 510 is developed by programming. Programs can be procedures, functions, triggers, or packages. They are stored on the server and help the business to finish creating and posting the banner advertisement.

The stored procedure is a procedure or function which consists of a set of java constructs. Procedures and functions are identical except that functions always return a single value to the caller, whereas the procedures do not. The trigger is a java program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include procedures and functions that are callable only from inside of the package. The functionality of a package is similar to that of stored procedures.

When Step 505 and 510 are done, the data will be generated (Step 515). The generated data needs to be verified (Step 520). If the verification raises an exception, the data becomes invalid. The process needs to go back to Step 505 and 510 by taking Step 525 and 530. After the verification is done, the data will be saved in the database on the server (Step 535). The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

Step 540 is making payment online. Payment information needs to be collected (Step 545). The collected information needs to be verified (Step 550). If it is invalid, the process will go back to Step 545 until the valid information is provided through Step 555. The data will be saved in the database on the server (Step 560) and the advertisement will be displayed (Step 565).

A notification will be sent to remind the business to renew the service (Step 570). The business have two options. The first is ignoring it, and the advertisement will be taken off (Step 575). The second option is renewing (Step 580). The business make the payment online before any data will be saved in the database on the server (Step 585). A new process will begin when the advertisement continues (Step 590).

Route 600 leads the business to VIP Ads Showroom at the first level after the business access their account. Step 605 is creating the front cover page. The front cover page can be either in the video or image format. The tools include the templates, editor, background colors, patterns, and canvas. The business can create the front cover page either by using the online design tools or upload the front cover page from the local machine. The next step is creating the text and video advertisement (Step 610). The business type the text advertisement content in the block. The video advertisement needs to be uploaded. The text and video advertisement need to be verified before they are submitted. Step 615 is creating online image advertisement. The business use the tools to create the image advertisement. The tools include the templates, background colors, patterns, editor and canvas. The generated data in Step 610 and 615 needs to be verified (Step 620). If the data is invalid, the process needs to go back until valid data is provided (Step 625 and 630). If the data is valid, it will be saved in the database on the server (Step 635).

Step 640 is making payment online. Payment information needs to be collected (Step 645). The collected information needs to be verified (Step 650). If the information is invalid, the process will go back until the valid information is provided (655). The verified data will be 665). The results refer to all the advertisement content designed for VIP Ads Showroom is successfully created.

A notification will be sent to remind the business to renew the service (Step 670). The business have two options before the process ends. The first choice is ignoring it and the service will stop when it expires (Step 675). The second choice is to renew (Step 680). After the information is updated (Step 685), the data will be saved in the database on the server. A new process will begin when the payment is made (Step 690).

Route 700 leads to Products Shown on TV at the first level after the business access their account. Step 705 is uploading the video advertisement from the local machine. The business initiates the request on the client's side. The server process starts the query. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the business to create the video advertisement by using the production tools and templates which include the steps to produce, edit, preview and submit.

After the file is fetched, it will be verified (Step 710). During the verification, the function program is invoked. It provides a default verification routine to verify the validity of the data. The procedure returns the value TRUE for success and FALSE for failure. If the verification raises an exception, the data becomes invalid. It will go back to Step 705 until the valid data is provided (Step 715). The data will be saved in the database on the server after the verification is done (Step 720).

The next two steps are making payment and data verification (Step 725, 730). If the payment information is valid, it will be submitted and saved (Step 735). If the information is invalid, the process will go back to Step 725 through Step 740 until valid information is provided. The video will be displayed (Step 745).

A notification will be sent to remind the business to renew the service (Step 750). The business have two options before the process ends. The first choice is ignoring it and the service will stop when it expires (Step 755). The second choice is renewing (Step 760). After the information is updated, the data will be saved in the database on the server (Step 765). A new process will begin after the payment is made (Step 770).

FIG. 2 (b) is a process flow diagram illustrating how advertisement self-creation is developed at the first level. Route 800 leads to Service Group 3. Service Group 3 includes Weekly, Monthly Ads Catalog, Quarterly Products Brochure, Coupons, Coupon Books, Export Products, and Import Products. Program Option 1A and 2A (Step 805, Step 810) are the steps that the business select to upload the front cover page and the catalog from the local machine. The business originate the request. The request is sent as the user process. The server parses the request. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done. The server usually translates each requirement, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. After the file is fetched, it will be previewed.

Program Option 1B and 2B (Step 815, 820) are the steps that the business select to create the front page and catalog by using the online design tools. The business use the online design tools and follow each process step before any data will be generated. The tools include templates, background colors, patterns, editor and canvas. After Step 805, 810, 815, and 820 is taken, the data will be created (Step 825). The generated data needs to be verified (Step 830). During the verification, the functional program is invoked. If the verification raises an exception, the data becomes invalid. The process needs to go back until the valid data is provided through Step 835. After the verification is done, the server will record the data and write them to the data blocks in the data files from database buffer cache (Step 840).

Step 845 is making payment and collecting payment information. The collected information needs to be verified (Step 850). If it is invalid, the process goes back to Step 845 until the valid data is provided (Step 855). If the data is valid, the data will be submitted and saved in the database on the server (Step 860). The catalogs will be displayed after the payment (Step 865).

A notification will be sent to remind the business to renew the service (Step 870). The business have two options before the process ends. The first is ignoring it and the service will stop when it expires (Step 875). The second choice is renewing (Step 880). After the information is updated (Step 885), the data will be saved in the database on the server (Step 890). A new process will begin after the payment is made (Step 895).

Route 900 leads the business to Service Group 4 after the business access their account. Service Group 4 includes Office Space & Suites and Warehouses & Distribution Centers. The business choose an area (Step 905). An area can be a city or a metro area in a state. The next step is for the business to upload the banner or video advertisement from the local machine (Step 910). The business initiate the request on the client's side. The server process starts the query. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the business to create the video advertisement by using the production tools and templates which include the steps to produce, edit, preview and post.

If the business take Step 915, the business will create the image advertisement by using the online design tools. The business follow the steps developed by the programs. The programs are program stored units. They can be procedures, functions, triggers, or packages. The process developed will help the user to finish creating and posting the banner advertisement. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include procedures and functions that are callable only from inside of the package. The functionality of a package is similar to that of stored procedures.

When Step 910 and 915 are done, the data will be generated (Step 920). The generated data need to be verified (Step 925). If the verification raises an exception, the data becomes invalid. The process will go back to Step 910 and 915 through Step 930 and 935. After the verification is done, the data will be saved in the database on the server (Step 940).

Step 945 is making payment and collecting payment information. The collected information needs to be verified (950). If it is invalid, the process will go back to Step 945 until the valid information is provided through Step 955. The data will be submitted and saved in the database on the server after the verification (Step 960). The advertisement will be displayed (Step 965).

A notification will be sent to remind the business to renew the service (Step 970). The business have two options before the process ends. The first choice is ignoring it and the service will stop when it expires (Step 975). The second choice is renewing (Step 980). After the information is updated (Step 985), the data will be saved in the database on the server (Step 990). A new process will begin after the payment is made (Step 995).

Route 1000 leads to Expose Business after the business access their account. Step 1005 is providing the information about their business. The next Step 1010 is selecting an industry and a location. A location is a designated area where the business choose to expose the business. Step 1015 is choosing to upload the advertisement or other materials from the local machine. The business initiates the request on the client's side. The server process starts the query. There are three stages in the process A). In parse, the request is passed from the user process, and a parsed representation of the request is loaded into the local computer. The server process searches for the existing request copy of the request on the local computer, validates the request by checking its syntax, performs data dictionary lookups to validate file definitions, acquires parse locks on the object, loads the request and execution plan into the buffer cache and sends back to the server for processing. B). Executing the requirement, at this point, the local computer has all the resources and necessary information, so the requirement is executed. The user process prepares to retrieve the data. C). Fetching, in this stage, the file is selected and returned by the user to the server.

If the business take Step 1020, the business will create image advertisement by using the online design tools. The design tools include the templates, background colors, patterns, editor and canvas. There are program units stored on the server to perform specific tasks. The business follow each step before any data will be generated (Step 1025). The generated data needs to be verified (Step 1030). If the verification raises an exception, the data becomes invalid. The process needs to go back to the previous step until the valid data is provided (Step 1035, 1040). After the verification is done, the server records the data and writes it to the data blocks in the data files from database buffer cache (Step 1045).

The next Step 1050 is making payment online and collecting payment information. The collected information needs to be verified (Step 1055). If it is invalid, the process will go back to Step 1050 until the valid information is provided through Step 1060. The verified data will be submitted and saved in the database on the server (Step 1065). The advertisement will be shown (Step 1070).

A notification will be sent to remind the business to renew the service (Step 1075). The business have two options before the process ends. The first choice is ignoring it and the service will stop when it expires (Step 1080). The second choice is renewing (Step 1085). After the information is updated (Step 1090), the data will be saved in the database on the server (Step 1095). A new process will begin after the payment is made (Step 1095A).

FIG. 2 (c) is a process flow diagram illustrating how advertisement self-creation is developed at the first level. Route 1100 leads to Marketing Tools after the business access their account. There are three options of Marketing Tools. Step 1105 (Program Option 1) is selecting a service from Service Group A. Service Group A is introduction, advertisement or promotion for the business in either graphic or video format. The business choose whether to create the service by using the online design tools or upload the design work from the local machine. If the business choose to upload the design work from the local machine (Step 1110), a user process will be initiated on the client's side. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server.

If the business choose to use the online design tools, Program Option 2 initiates (Step 1115). The developed process will help the business finish the work. The design tools and process steps are developed by Java. After the business follow each step, the data will be generated (Step 1120). The generated data needs to be verified (Step 1125). If the data is invalid, the process will go back until the valid data is provided (Step 1130). The business choose the business contacts (Step 1135), and send the created materials (Step 1140). The generated data will be saved and stored in the database for future use (Step 1145). The process will end when the business pick another service or log out (Step 1150).

Step 1155 is a module developed for the business to build and keep the relationship with the customers (Program Option 3). They are designed for the business to build and keep relationship with their clients in text format. The business need to select a category in Service Group 2 and create content (Step 1160). After it is done, the data will be generated (Step 1165). The generated data needs to be verified (Step 1170). If the data is invalid, the process needs to go back to Step 1160 until the valid data is provided (Step 1175). The business select the business contacts (Step 1180), and send the created content (Step 1185). The data will be saved and stored in the database for future use (Step 1190). The process will end when the business pick another service or log out (Step 1195).

Route 1200 leads the business to Authorized Agents. Step 1205 is providing business information. After the data is collected, it needs to be verified (Step 1210). If the data is invalid, the process will go back until the valid information is provided (Step 1215). If the data is valid, the data will be saved in the database (Step 1220). The process will end when the business pick another service or log out (Step 1225).

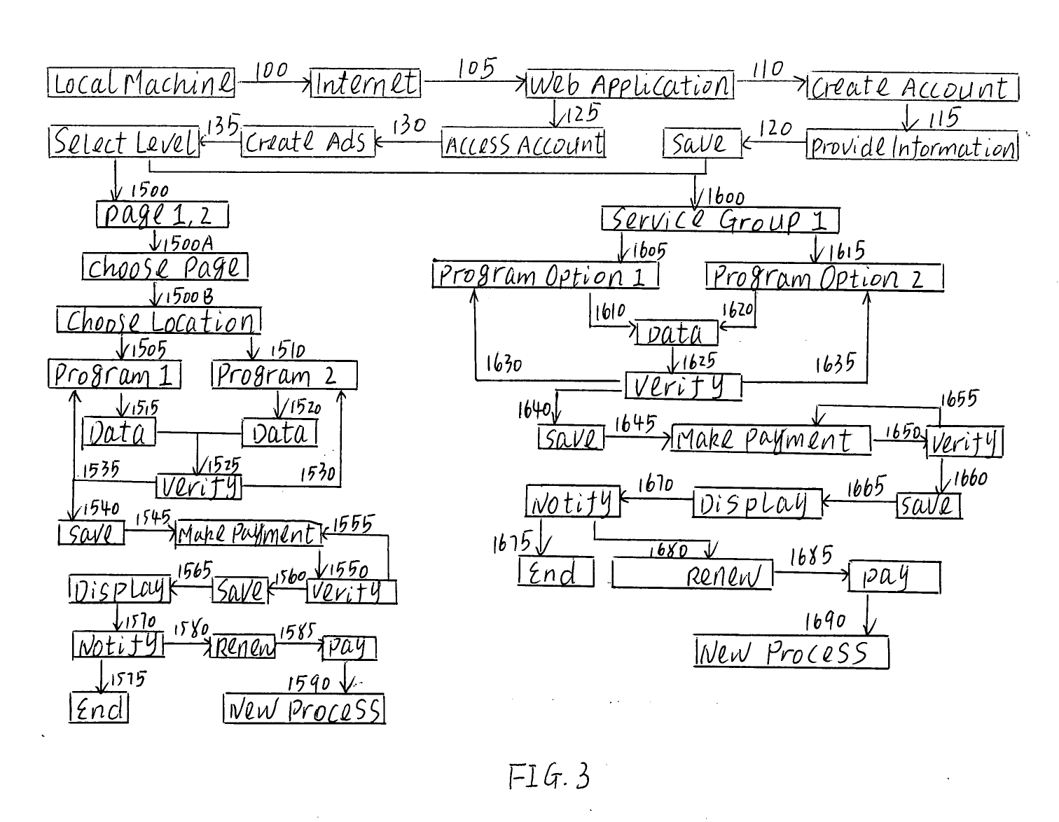

FIG. 3 is a process flow diagram illustrating how self-creation advertisement is developed at the second level. The second level is also the state level. The second level consists of different web pages. Among the web pages there are different services that are built on them. One of the services is the banner and video advertisement spot locations that are created on each web page. Other service groups are built at the second level as well. The business can choose different services on different pages and create advertisement by themselves.

The business connect to the web server through the interne (Step 100). The connection is a communication pathway between the user and server process. A process created on the client's side is called user process. The user originates the request. The server listens, receives, parses and executes the request sent from the user process. This process is called the server process. The server process communicates with the server on behalf of the user process. The server process executes the request and sends the result back to the user.

The web application displays the graphic interface which is the first page at the second level (Step 105). The interface of the first page at the second level consists of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the second level (Step 135).

Route 1500 leads to create the banner or video advertisement on the first or second page at the second level. The first and second pages at the second level consist of items. Items are used to present information from the database or to act as a control. The web application is event-driven. If an event occurs, the program responds to it. An event is either an interface event, which corresponds to a user action, or an internal processing event, which corresponds to a system action. Step 1500A is choosing a page. Step 1500B is choosing a location.

There are different banner and video advertisement spots on the first and second page at the second level. The advertisement spots are developed blocks. The business have the option to take Step 1505 or Step 1510. Step 1510 contains the tools and the process to help the business create the banner advertisement. The tools include the templates, background colors, patterns, canvas and editor. The business pick a template, chooses background color from the galleries, select a canvas and a pattern, use the editor and follow each step before the banner advertisement will be created (Step 1520).

If the business choose to create the video advertisement, the business will take the Step 1505. Program Option 1 initiates the process. Program Option 1 is developed to help the business with the video advertisement. The process will send query on the local machine. If the query is successful, it returns the video file as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 1515)

The generated data in Step 1505 and Step 1510 needs to be verified (Step 1525). During the verification, the functional program is invoked. If the verification raises an exception, the data becomes invalid. The process needs to go back to Step 1530 or Step 1535 until the valid data is provided. If the data is valid, the server records the data and writes it to the data blocks in the database from database buffer cache (Step 1540). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next Step 1545 is making the payment and collecting payment information. After the data is collected, it needs to be verified (Step 1550). The verification includes the company or personal information such as company or personal name, company address, credit card number, expiration date, security code, bank Route number and account number. If the data is invalid, the process will take Step 1555 and go back to Step 1545 until the valid data is provided. If the data is valid, it will be submitted and saved in the database (Step 1560), and the video advertisement will be shown on the spot that the business pick (Step 1565).

A notification will be sent to remind the business to renew the service (Step 1570). The business have two options before the process ends. The first choice is ignoring it and the service will stop when it expires (Step 1575). The second choice is renewing (Step 1580). After the information is updated, the data will be saved in the database (Step 1585). A new process will begin after the payment is made (Step 1590).

Posting banner or video advertisement on the first page at the second level is developed by Java. Java is a language used for compiling programs which are stored units. They enable the user to access the website and manipulate procedural schema objects. Stored program units are logically related sets of language statements that perform specific tasks. They can be procedures, functions, triggers, or packages and are created and stored in the data dictionary. The stored procedure is a procedure or function which consists of a set of Java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package. B). The body implements the specification. It includes the compiled codes to implement the procedure and function specification included in the package specification. It may also include procedures and functions that are callable only from inside of the package. The functionality of a package is similar to that of stored procedures.

Route 1600 leads the business to Service Group 1 at the second level. Service Group 1 includes Wholesale to All, Business Opportunities, Finance-Investment, Franchises, Events, Auctions, and Announcements. Step 1605 is choosing Program Option 1. Program Option 1 is the process developed to help the business upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 1610)

The business choose Program Option 2 (Step 1615). Program Option 2 is the process to create the image advertisement by using the online tools. The business use the design tools and follow each step to create and post the banner advertisement. The design tools include the templates, background colors, patterns, editor and canvas. The process steps are developed by the programs. They can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include the procedures and functions that are callable only from inside of the package. The functionality of a package is similar to that of stored procedures.

After Step 1605 and 1615 are done, the data will be generated (Step 1620). The generated data needs to be verified (Step 1625). If the verification raises an exception, the data becomes invalid. The process will go back to Step 1605 and 1610 by taking Step 1630 and Step 1635. After the verification is done, the data will be saved in the database (Step 1640). The next step is making payment and collecting information (Step 1645). The collected information needs to be verified (1650). If it is invalid, the process will go back to Step 1645 until the valid data is provided (Step 1655). The data will be submitted and saved in the database (Step 1660). The advertisement will be shown (Step 1665).

A notification will be sent to remind the business to renew the service (Step 1670). The business have two options before the process ends. The first choice is ignoring it and the service will stop when it expires (Step 1675). The second choice is renewing (Step 1680). After the information is updated, the data will be saved in the database (Step 1685). A new process will begin after the payment is made (Step 1690).

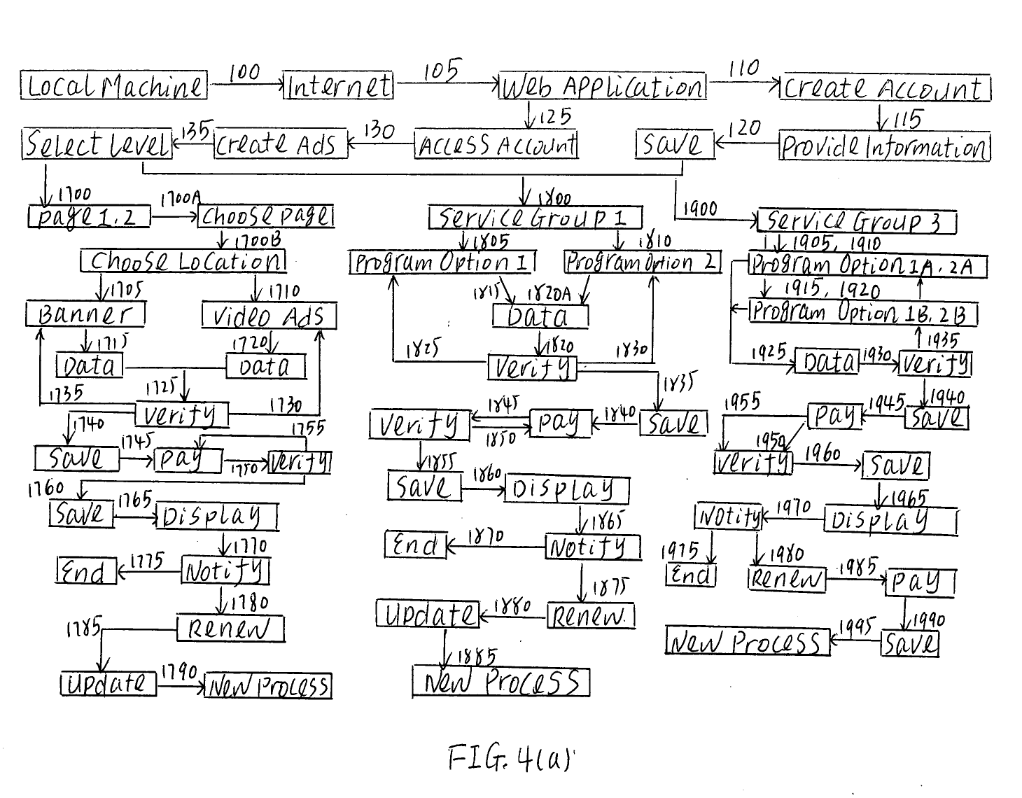

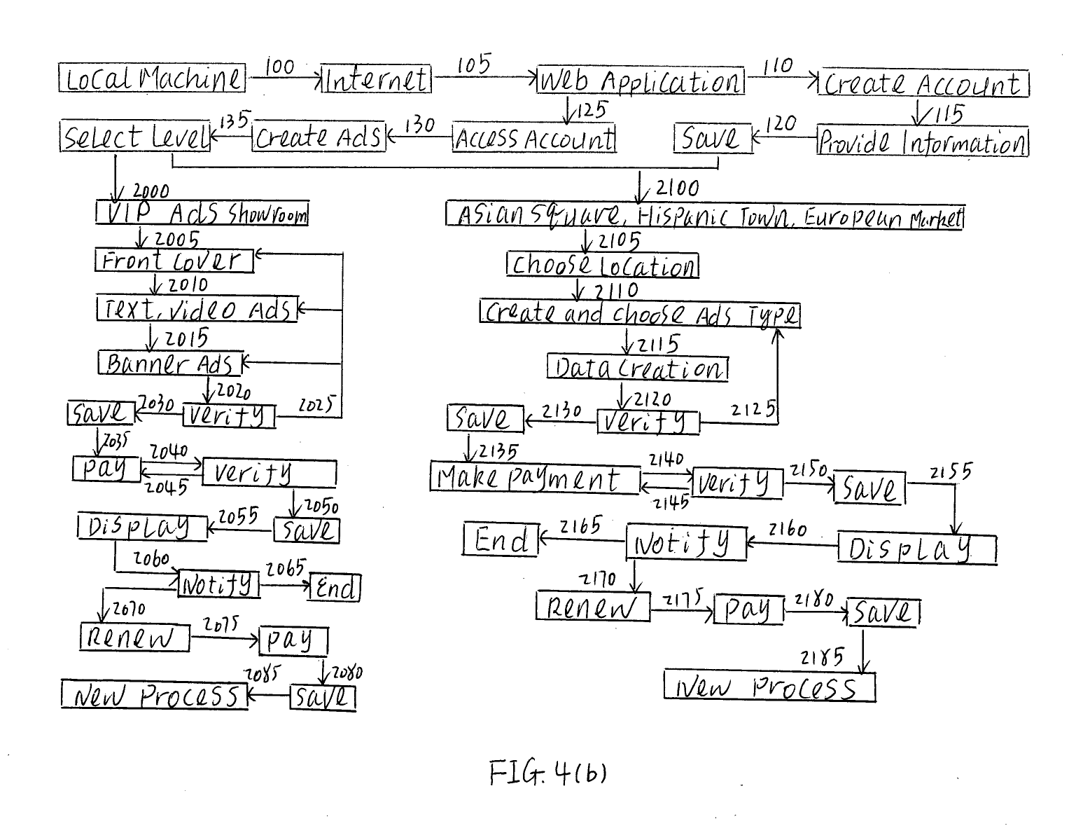

FIG. 4 (a) is a process flow block diagram illustrating how advertisement self-creation is developed at the third level. The third level is also the metro area level. The third level consists of different web pages. Among the web pages there are different services that are built on them. One of the services is the banner and video advertisement spot locations that are created on each web page. Other service groups are built at the third level as well. The business can choose different services on the web pages and create advertisement by themselves.

The business connect to the web server through the internet (Step 100). The connection is a communication pathway between the user and server process. A process created on the client's side is called the user process. The business originate the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page consists of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the third level (Step 135).

Route 1700 leads to creating banner or video advertisement on the first or second page at the third level. Step 1700A is choosing a page. Step 1700B is choosing a location. Step 1705 is for the business to create the banner advertisement. Step 1710 is to create the video advertisement. Step 1705 contains the tools and the process steps. The tools include custom designed advertising templates, background colors, patterns, canvas and editor. The process steps are developed by the programs. They help the business finish creating the banner advertisement. In Step 1715 the business pick a design from the templates. The business can change the background color and pattern, insert a picture or image, and change the font size and location. The business need to follow each step to finish creating and posting the banner advertisement. The programs are stored units. They enable the user to access website and manipulate procedural schema objects. The stored program units are logically related sets of language statements that perform specific tasks. They can be procedures, functions, triggers, or packages and are created and stored in the data dictionary.

The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package, B). The body implements the specification. It includes the compiled codes to implement the procedure and function specification included in the package specification. It may also include procedures and functions that are callable only from inside of the package. The functionality of a package is similar to that of stored procedures.

If the business choose to create the video advertisement, the business will take Step 1710. Program Option 1 initiates the process. Program Option 1 is developed to help the business with the video advertisement. The process will send query on the local machine. If the query is successful, it will return the video file as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 1720).

The data generated in Step 1705 and Step 1710 needs to be verified (Step 1725). During the verification, the functional program is invoked. If the verification raises an exception, the data become invalid. The process needs to be back to the Step 1705 and the Step 1710 until the valid data is provided through Step 1730 or 1735. If the data are valid, the server records the data and writes them to the data blocks in the database from database buffer cache (Step 1740). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next step making the payment online (Step 1745). The payment information needs to be collected. After the data is collected, it needs to be verified (Step 1750). The verification includes the company or personal information such as the company or personal name, company address, credit card number, expiration date, security code, bank Route number and account number. If the data is invalid, the process will take the Step 1755 and go back to the Step 1745 until the valid data is provided. If the data is valid, it will be submitted and saved in the database (Step 1760), and the video advertisement will be displayed on the spot that the business picks (Step 1765).

A notification will be sent to remind the business to renew the service (Step 1770). The business have two options before the process ends. The first choice is ignoring it and the service will stop when it expires (Step 1775). The second choice is renewing (Step 1780). After the information is updated, the data will be saved in the database (Step 1785). A new process will begin after the payment is made (Step 1790).

Route 1800 leads the business to Service Group 1 at the third level. Service Group 1 includes Wholesale to All, On Sale, Special Deals, Clearance, Closeouts, Overstocks, Tent Events, Products & Services Promotion, Business Opportunities, Finance-Investment, Franchises, Events, Workshops-Seminars, Auctions, and Announcements. Step 1805 is choosing Program Option 1. Program Option 1 is the process developed to help the business upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 1815)

The business choose Program Option 2 (Step 1810). Program Option 2 is the process to create the image advertisement by using the online tools. The business use the design tools and follows each step to create and post the banner advertisement. The design tools include the templates, background colors, patterns, editor and canvas. The process steps are developed by the programs. They can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package, B). The body implements the specification. It includes the compiled codes to implement the procedure and function specification included in the package specification. It may also include the procedures and functions that are callable only from inside of the package. The functionality of a package is similar to that of stored procedures.

After Step 1805 and 1810 are done, the data will be generated (Step 1815). The generated data needs to be verified in Step 1820(A). If the verification raises an exception, the data becomes invalid. The process will go back to Step 1805 and 1810 by taking Step 1825 and Step 1830. After the verification is done, the data will be saved in the database (Step 1835). The next step is making payment and collecting information (Step 1840). The collected information needs to be verified (1845). If it is invalid, the process will go back to Step 1840 until the valid data is provided (Step 1850). The data will be submitted and saved in the database (Step 1855). The advertisement will be shown (Step 1860).

A notification will be sent to remind the business to renew the service (Step 1865). The business have two options before the process ends. The first choice is ignoring it and the service will stop when it expires (Step 1870). The second choice is renewing (Step 1875). After the information is updated, the data will be saved in the database (Step 1880). A new process will begin after the payment is made (Step 1885).

Route 1900 leads the business to Service Group 3 at the third level. Service Group 3 includes Monthly Ads Catalog, Quarterly Products Brochure, Coupons and Coupon Books. Program Option 1A and 2A (Step 1905, Step 1910) are the steps that the business select to upload the front cover page and the catalog from the local machine. The business originate the request. The server parses the request. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. After the file is fetched, it will be previewed.

Program Option 1B and 2B (Step 1915 and 1920) are creating the front page and catalog by using the online tools. The business use the online design tools and follow each process step before any data will be generated. The tools include templates, background colors, patterns, editor and canvas. After each step is taken, the data will be created (Step 1925). The generated data needs to be verified (Step 1930). During the verification, the functional program is invoked. If the verification raises an exception, the data becomes invalid. The process will go back until the valid data is provided through Step 1935. After the verification is done, the server will record the data and write them to the data blocks in the data files from the database buffer cache (Step 1940).

Step 1945 is making payment. Payment information will be collected. The collected information needs to be verified (Step 1950). If it is invalid, the process goes back to Step 1945 until the valid data is provided (Step 1955). The verified data will be submitted and saved in the database on the server (Step 1960). The catalogs will be displayed after the payment (Step 1965).

A notification will be sent to remind the business to renew (Step 1970). The business have two options before the process ends. The first choice is ignoring it and the service will stop when it expires (Step 1975). The second choice is renewing (Step 1980). After the information is updated (Step 1985), the data will be saved in the database on the server (Step 1990). A new process will begin after the payment is made (Step 1995).

FIG. 4 (b) is a process flow diagram illustrating how advertisement is developed at the third level. Route 2000 is related to VIP Ads Showroom. Step 2005 is creating the front cover page. The front cover page will either be in the video or image format. The tools include the templates, editor, background colors, patterns, and canvas. The business can create the front cover page either by using the online design tools or upload the front cover page from the local machine. The next Step 2010 is creating the text and video advertisement. The business type the text ad content in the block. The video advertisement needs to be uploaded. Step 2015 is creating online image advertisement. The business use the online tools to create the image advertisement. The tools include the templates, background colors, patterns, editor and canvas. The generated data needs to be verified (Step 2020). If the data is invalid, the process will go back until the valid data is provided (Step 2025). After the verification is done, the data will be saved in the database on the server (Step 2030).

Step 2035 is making payment online. Payment information needs to be collected. The collected information needs to be verified (Step 2040). If the information is invalid, the process will go back until the valid information is provided (Step 2045). The verified data will be submitted and saved in the database on the server (Step 2050). The results will be displayed (Step 2055). The results refer to all the advertisement content designed for VIP Ads Showroom is successfully created.

A notification will be sent to remind the business to renew the service (Step 2060). The business have two options before the process ends. The first choice is ignoring it and the service will stop when it expires (Step 2065). The second choice is renewing (Step 2070). After the information is updated (Step 2075), the data will be saved in the database on the server (Step 2080). A new process will begin when the payment is made (Step 2085).

Route 2100 leads to Asian Square, Hispanic Town and European Market at the third level. Step 2105 is choosing one of the three locations. When the location is selected. The business can choose either text, banner or video advertisement (Step 2110). The business need to follow each step before the data is generated (Step 2115). The generated data needs to be verified (Step 2120). If the data is invalid, the process needs to be back until the valid data is provided (Step 2125). After the verification is done, the server records the data and writes it to the data blocks in the data files from database buffer cache (Step 2130).

The next step (Step 2135) is making payment online. The collected payment information needs to be verified (Step 2140). If it is invalid, the process will go back to Step 2135 until the valid data is provided by taking Step 2145. The verified data will be saved in the database (Step 2150). The text advertisement will be shown after the payment (Step 2155). The business will be notified (Step 2160) before the advertisement expires. If the business ignore it, the advertisement will be taken offline (Step 2170). The process will end when the advertisement expires (Step 2165). If the business renew, the business need to update information (Step 2175). After the update, the data will be saved in the database (Step 2180). A new process will begin when the advertisement continues (Step 2185).

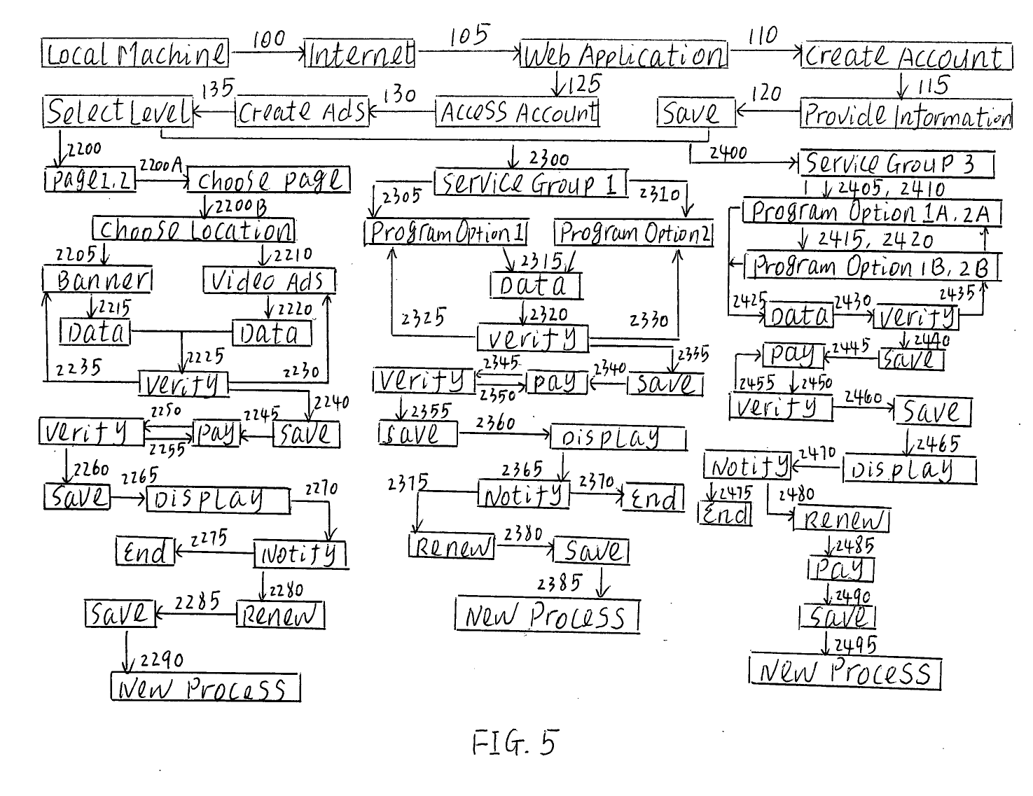

FIG. 5 is a process flow block diagram illustrating how video and banner advertisement are created at the fourth level. The fourth level is also the city level. Route 2200 leads to create banner or video advertisement on the first page or second page at the fourth level. The first and second page of level four consists of items. Items are used to present information from the database or to act as a control. The web application is event-driven. When an event is triggered, the program responds to it. An event is either an interface event, which corresponds to a user action, or an internal processing event, which corresponds to a system action. The banner and video advertisement spots on the first and second page are developed blocks. The business select an available spot to create the banner or video advertisement. Step 2200A is choosing a page. Step 2200B is choosing a location.

Step 2205 is creating the banner advertisement. Step 2210 is creating the video advertisement. Step 2205 contains the tools and the process steps. The tools include custom designed advertising templates, background colors, patterns, canvas and editor. The process steps are developed by the programs. They help the business finish creating the banner advertisement. In Step 2215 the business need to pick a design from the templates. The business can change the background color and pattern, insert a picture or image, and change the font size and location. The business follow each step to finish creating the banner advertisement. Creating banner advertisement is developed by programs. The programs are stored units. They help the business to access and manipulate database information using procedural schema objects. The stored program units are logically related sets of language statements that perform specific tasks. They can be procedures, functions, triggers, or packages and are created and stored in the data dictionary.

The stored procedure is a procedure or function which consists of a set of Java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package. B). The body implements the specification. It includes the compiled codes to implement the procedure and function specification included in the package specification. It may also include procedures and functions that are callable only from inside of the package. The functionality of a package is similar to that of stored procedures.

If the business choose to create the video advertisement, the business take Step 2210. Program Option 1 initiates the process. Program Option 1 is developed to help the business with the video advertisement. The process will send query on the local machine. If the query is successful, it will return the video file as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data is generated (Step 2220). The advertisement created from Step 2205 and 2210 needs to be verified (Step 2225). If the data is invalid, the process needs to go back to the previous steps through Step 2230 and 2235 until the valid data is provided. If the data is fine, it will be saved (Step 2240).

The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

Step 2245 is making the payment online. The payment information needs to be collected. After the data is collected, it needs to be verified (Step 2250). The verification includes information such as the company or personal name, company address, credit card number, expiration date, security code, bank Route number and account number. If the data is invalid, the process will take the Step 2255 and go back to Step 2245 until the valid data is provided. If the data is valid, it will be submitted and saved in the database (Step 2260). The video advertisement will be displayed on the spot that the business pick (Step 2265).

The business will be notified to renew the service (Step 2270). The business have two options before the process ends. The first choice is ignoring it and the service will stop when it expires (Step 2275). The second choice is renewing (Step 2280). After the information is updated, the data will be saved in the database (Step 2285). A new process will begin after the payment is made (Step 2290).

Route 2300 leads the business to Service Group 1 at the fourth level. Service Group 1 includes On Sale, Special Deals, Overstock, Clearance, Closeouts, Products & Services Promotion, Business Opportunities, Events, and Announcements. The business choose Program Option 1 (Step 2305). Program Option 1 is the process developed to help the business upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 2315).

The business choose Program Option 2 (Step 2310). Program Option 2 is creating the image advertisement by using the online tools. The business use the design tools and follow each step to create and post the banner advertisement. The design tools include the templates, background colors, patterns, editor and canvas. The process steps are developed by the programs. They can be procedures, functions, triggers, or packages and are created and stored in the data dictionary as a schema object. The stored procedure is a procedure or function which consists of a set of Java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the codes to implement the procedure and function specification included in the package specification. It may also include the procedures and functions that are callable only from inside of the package. The functionality of a package is similar to that of stored procedures.

After Step 2305 and Step 2310 are done, the data will be generated (Step 2315). The generated data needs to be verified (Step 2320). If the verification raises an exception, the process will go back to Step 2305 and 2310 by taking Step 2325 and Step 2330. After the verification is done, the data will be saved in the database (Step 2335). The next step is making payment (Step 2340). The collected information needs to be verified (2345). If it is invalid, the process will go back to Step 2340 until the valid data is provided (Step 2350). The data will be submitted and saved in the database (Step 2355). The advertisement will be shown (Step 2360).

The business will be notified to renew (Step 2365). The business have two options before the process ends. The first choice is ignoring it and the service will stop when it expires (Step 2370). The second choice is renewing (Step 2375). After the information is updated, the data will be saved in the database (Step 2380). A new process will begin after the payment is made (Step 2385).

Route 2400 leads to Service Group 3. Service Group 3 includes Coupons and Coupon Books are designed at the fourth level. The business take Step 2405 (Program Option 1A) to upload the front cover page from the local machine. The business originate the request on the client's side. The server parses the request. There are three stages in the process A). In parse, the request is passed from the user process, and a parsed representation of the request is loaded into the local computer. During the parse, the server process searches for the existing request copy of the request on the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. After the data file is fetched, it will be previewed. Step 2410 (Program Option 1 B) is uploading the content materials from the local machine. After the data is fetched, the data will be previewed.

Step 2415 and 2420 (Program Option 2A, 2B) are the steps that the business select to create the front page and content materials by using the online design tools. The business use the tools and follow each step to complete the design work. The tools include the templates, background colors, patterns, editor and canvas. The steps are developed by the programs stored in the files. After each step is taken, the data will be generated (Step 2425).

The generated data from Step 2405, 2410, 2415, and 2420 needs to be verified (Step 2430). If the verification raises an exception, the business need to repeat the process until the valid data is provided (Step 2435). After the verification is done, the server records the data and writes it to the data blocks in the data files from database buffer cache (Step 2440).

Step 2445 is making payment online. The collected payment information needs to be verified (Step 2450). If it is invalid, the process will go back to the Step 2445 until the valid information is provided through Step 2455. The verified data will be submitted and saved in the database (Step 2460). The coupon or coupon books will be shown (Step 2465).

The business will be notified to renew the service (Step 2470). The business have two options before the process ends. The first choice is ignoring it and the service will stop when it expires (Step 2475). The second choice is renewing (Step 2480). After the information is updated (Step 2485), the data will be saved in the database on the server (Step 2490). A new process will begin when the payment is made (Step 2495).

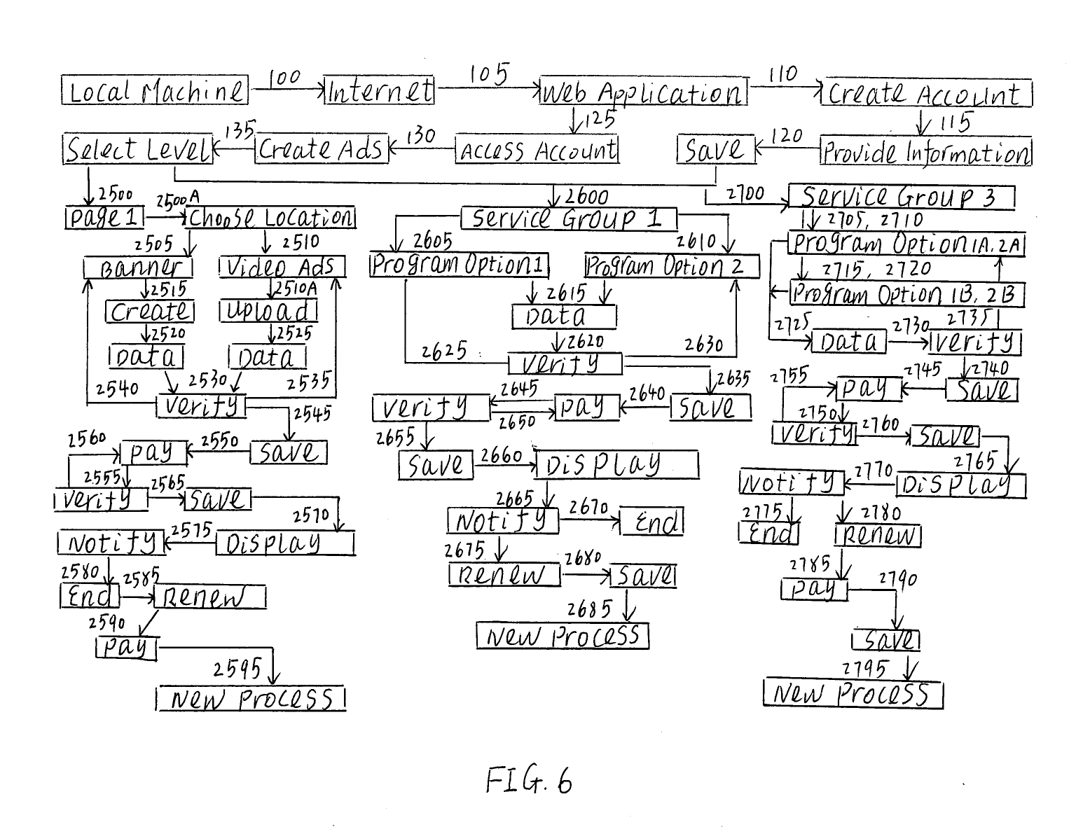

FIG. 6 is a process flow block diagram illustrating how video and banner ads are created at the fifth level. The fifth level is also the business listing level. Route 2500 leads to the first page at the fifth level. The fifth page consists of items. Items are used to present information from the database or to act as a control. The web application is event-driven. When an event is triggered, the program responds to it. An event is either an interface event, which corresponds to a user action, or an internal processing event, which corresponds to a system action. The banner and video advertisement spots on the first page are developed blocks. The business select an available spot to create the banner or video advertisement (Step 2500A).

Step 2505 is creating the banner advertisement. Step 2510 is creating the video advertisement. Step 2505 contains the tools and the process steps. The tools include custom designed advertising templates, background colors, patterns, canvas and editor. The process steps are developed by the programs. They help the business finish creating the banner advertisement. In Step 2515 the business pick a design from the templates. The business can change the background color and pattern, insert a picture or image, and change the font size and location. The business follow each step to finish creating banner advertisement (Step 2520). The programs are stored units. They enable the user to access the website and manipulate procedural schema objects. The stored program units are logically related sets of language statements that perform specific tasks. They can be procedures, functions, triggers, or packages and are created and stored in the data dictionary as a schema object.

The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package. B). The body implements the specification. It includes the compiled codes to implement the procedure and function specification included in the package specification. It may also include procedures and functions that are callable only from inside of the package. The functionality of a package is similar to that of stored procedures.

If the business choose to create the video advertisement, the business take Step 2510 to upload. The program initiates the process. The process will send query on the local machine. If the query is successful, it will return the video file as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated (Step 2525).

The generated data in Step 2510 and Step 2520 needs to be verified (Step 2530). If the data is invalid, the process will go back to Step 2535 and Step 2540 until the valid data is provided. If the data is valid, the server records the data and writes them to the data blocks in the database from database buffer cache (Step 2545). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next Step 2550 is making the payment online. The payment information needs to be collected. After the data is collected, it needs to be verified (Step 2555). During the verification, the functional program is invoked. If the verification raises an exception, the data become invalid. The verification includes the company or personal information such as the company or personal name, company address, credit card number, expiration date, security code, bank Route number and account number. If the data is invalid, the process will take Step 2560 and go back to Step 2550 until the valid data is provided. If the data is valid, it will be submitted and saved in the database (Step 2565). The video advertisement will be shown on the spot that the business pick (Step 2570).

The business will be notified to renew (Step 2575). The business have two options before the process ends. The first choice is ignoring it and the service will stop when it expires (2580). The second choice is renewing (Step 2585). After the information is updated, the data will be saved in the database (Step 2590). A new process will begin after the payment is made (Step 2595).

Route 2600 leads to Service Group 1 at the fifth level. The service group 1 includes On Sale, Special Deals, Overstock, Clearance, and Closeouts. Step 2605 is choosing Program Option 1. Program Option 1 is the process developed to help the business upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be generated.

The business choose Program Option 2 (Step 2610). Program Option 2 is creating the image advertisement by using the online tools. The business use the design tools and follows each step to create and post the banner advertisement. The design tools include the templates, background colors, patterns, editor and canvas. The process steps are developed by the programs. They can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include the procedures and functions that are callable only from inside of the package. The functionality of a package is similar to that of stored procedures.

After the Step 2605 and 2610 are done, the data will be generated (Step 2615). The generated data needs to be verified (Step 2620). If the verification raises an exception, the data becomes invalid. The process needs to be back to Step 2605 and 2610 by taking Step 2625 and Step 2630. After the verification is done, the data will be saved in the database (Step 2635). The next step is making payment and collecting information (Step 2640). The collected information needs to be verified (2645). If it is invalid, the process will go back to Step 2640 until the valid data is provided (Step 2650). The data will be submitted and saved in the database (Step 2655). The advertisement will be shown (Step 2660).

The business will be notified to renew the service (Step 2665). The business have two options before the process ends. The first choice is ignoring it and the service will stop when it expires (Step 2670). The second choice is renewing (Step 2675). After the information is updated, the data will be saved in the database (Step 2680). A new process will begin after the payment is made (Step 2685).

Route 2700 leads the business to Service Group 3 at the fifth level. Service Group 3 includes Coupons and Coupon Books. Step 2705 (Program Option 1A) is uploading the front cover page from the local machine. The business originate the request on the client's side. The server parses the request. There are three stages in the process. A). In parse, the request is passed from the user process, and a parsed representation of the request is loaded into the local computer. During the parse, the server process searches for the existing request copy of the request on the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. One or more fetches may be required to transfer the result of a query to the user. After the data file is fetched, it will be previewed. Step 2710 (Option 2A) followed by Program Option 2A is the step that the business uploads the content materials from the local machine. After the data is fetched, the data will be previewed.

Step 2715 and 2720 (Program Option 1B and 2B) are the steps that the business select to create the front page and the material(s) by using the online design tools. The business use the tools and follow each step to complete the design work. The tools include the templates, background colors, patterns, editor and canvas. The steps are developed by the programs stored in the files. After each step is taken, the data will be generated (Step 2725).

The generated data from Program Option A and B needs to be verified (Step 2730). If the data is invalid, the process will go back until the valid data is provided (Step 2735). After the verification is done, the server records the data and writes it to the data blocks in the data files from database buffer cache (Step 2740).

Step 2745 is making payment online. The collected payment information needs to be verified (Step 2750). During the verification, the functional program is invoked. If the verification raises an exception, the data becomes invalid. If it is invalid, the process will go back to Step 2745 until the valid information is provided through Step 2755. The verified data will be submitted and saved in the database (Step 2760. The coupon or coupon books will be shown (Step 2765).

The business will be notified to renew the service (Step 2770). The business have two options before the process ends. The first choice is ignoring it and the service will stop when it expires (Step 2775). The second choice is renewing (Step 2780). After the information is updated (Step 2785), the data will be saved in the database (Step 2790). A new process will begin when the payment is made (Step 2795).

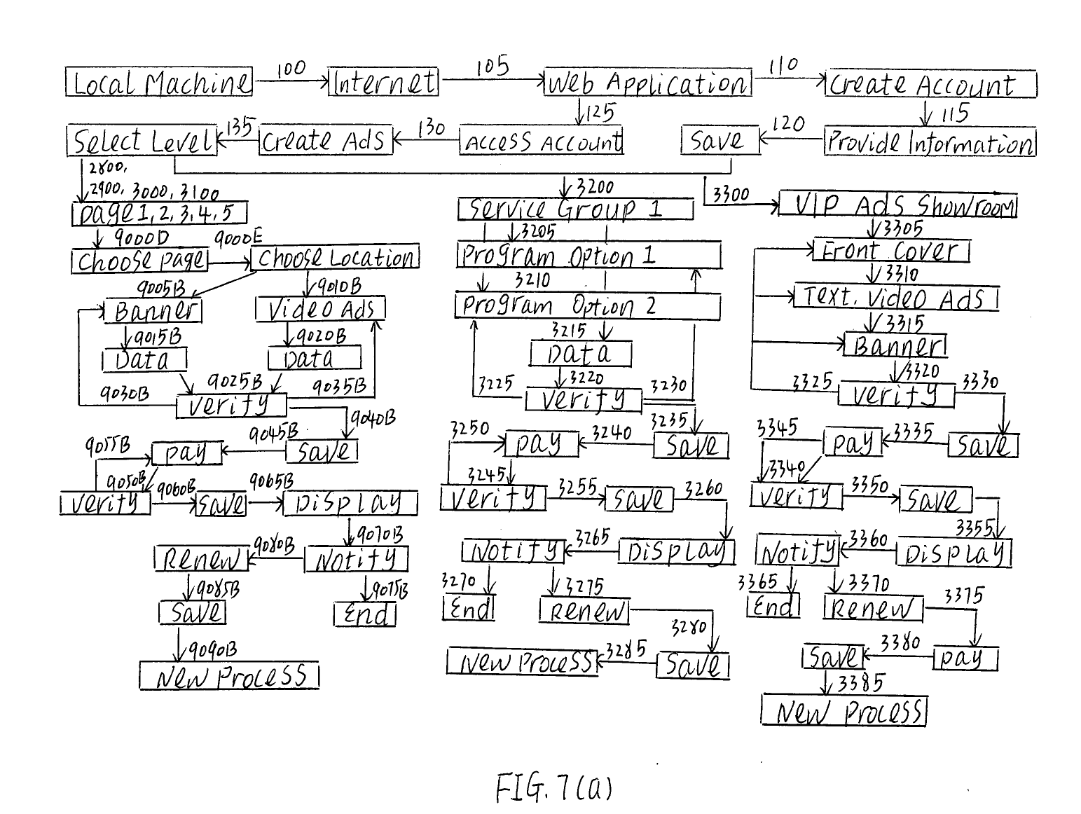

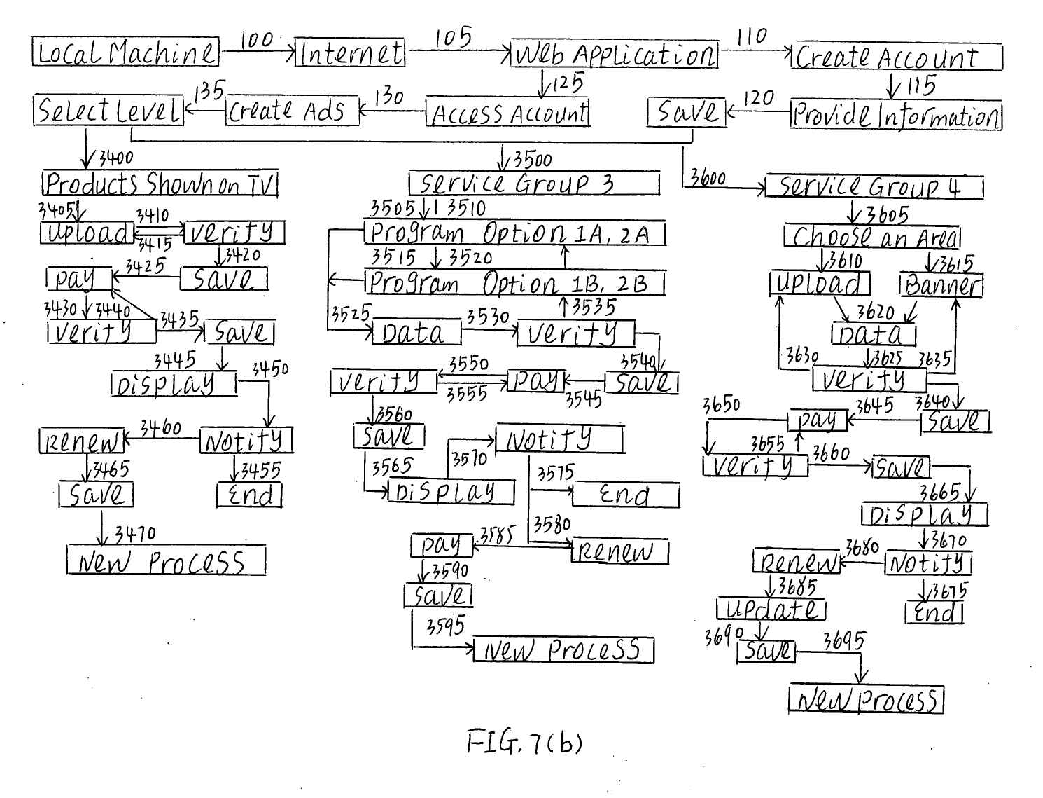

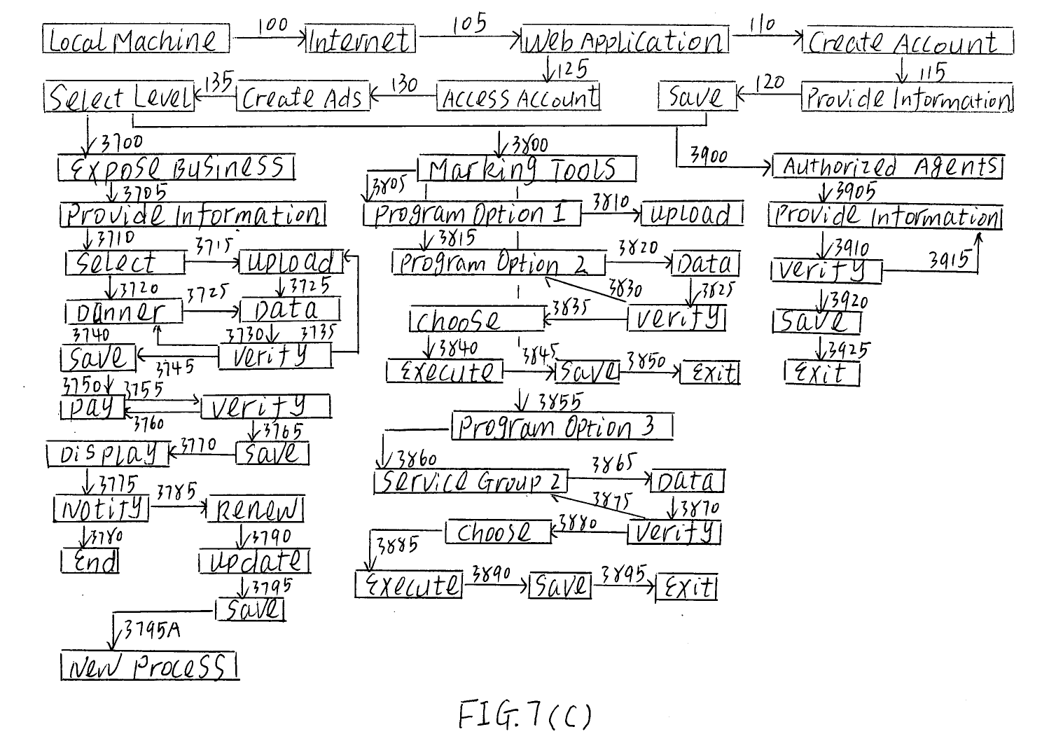

FIG. 7 (a) is a process flow diagram illustrating how video and banner advertisement are developed at the sixth level. The sixth level is also the industrial national level. The sixth level consists of different web pages. Among the web pages there are different services that are built on them. One of the services is the banner and video advertisement spot locations that are created on each web page. Other service groups are built at the sixth level as well. The business can choose different services on the web pages and create advertisement by themselves.

The business connect to the web server through the Internet (Step 100). The connection is a communication pathway between the user and server process. A process created on the client's side is called the user process. The business originate the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface is made up of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the sixth level (Step 135).

Route 2800, 2900, 3000 and 3100 lead to choosing and creating banner or video advertisement on page 1, 2, 3 at the sixth level. When the industrial national level is selected, all the web pages at the industrial national level will be displayed on one screen. The screen and webpage can be extended to full size if they are clicked. Step 9000D is picking a page. Clicking one of the pages will begin the process of posting either the video or banner advertisement (Step 9000E).

In Step 9000E the business have the option to take the Step 9005B or the Step 9010B. Step 9005B has more steps before getting the result. The Step 9010B has fewer. The result refers to creating and posting the advertisement successfully. Step 9005B contains the tools and programs developed for the business to post banner advertisement. The tools include custom designed advertising templates, background colors, patterns, canvas and editor. The programs are stored units. They help the business finish creating the advertisement. In Step 9005B the business need to pick a template, choose background color from the galleries, select a canvas and a pattern, and use the editor to create the banner advertisement. The business follow each step before the banner advertisement will be successfully created (Step 9015B).

Step 9000B is programmed by Java. The programs enable the user to access the website and manipulate procedural schema objects. The programs are a logically related set of language statements that perform a specific task. They are called by triggering. They can be procedures, functions, triggers, or packages and are created and stored in the data dictionary. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package, B). The body implements the specification. It includes the compiled codes to implement the procedure and function specification included in the package specification. It may also include procedures and functions that are callable only from inside of the package. The functionality of a package is similar to that of stored procedures.

if the business choose to go through Step 9010B, the process sends the query on the local machine. If the query is successful, it returns the file data as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program 1 has the option for the business to create the video advertisement by using the production tools and templates which include the steps of produce, edit, preview and post. After the video advertisement is uploaded or produced, the data is generated (Step 9020B).

The generated data from the Step 9015B and Step 9020B needs to be verified (Step 9025B). During the verification, the functional program is invoked. If the verification raises an exception, the data becomes invalid. The process needs to be back to Step 9005B and Step 9010B by taking Step 9030B and Step 9035B until the valid data is provided. If the data is valid, the server records the data and writes it to the data blocks in the database from database buffer cache (Step 9040B). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next is making payment and collecting payment information (Step 9045B). After the information is collected, it needs to be verified (Step 9050B). The verification includes the company or personal information such as the company or personal name, company address, credit card number, expiration date, security code, bank Route number and account number. If the data is invalid, the process will take Step 9055B until the valid data is provided. If the data is valid, it will be submitted and saved in the database (Step 9060B). The result will be shown (Step 9065B). The result refers to the successful creating and posting either the banner or video advertisement on the front page.

The business will be notified to renew the service in Step 9070B. The business have two options. The first option is ignoring it, and the advertisement will be taken off automatically (Step 9075B). The second option is renewing (Step 9080B). The business need to make the payment online before any data will be saved in the database (Step 9085B). A new process will begin when the advertisement continues (Step 9090B).

Route 3200 leads to Service Group 1 at the sixth level. The service group 1 includes Aftermarket parts, Aftermarket products, Wholesale to All, On Sale, Special Deals, Clearance, Closeouts, Access Inventory, Liquidation Sales, National Tent Events, New & Unique Products, Discount Products, Fresh Produce, Raw Materials, OEM Parts, OEM Products, Quality Products, Hot Products, Refurbished Products, Products & Services Promotion, Business Opportunities, Finance-Investment, Franchises, Events, Trade Shows-Conventions, Workshops-Seminars, Auctions, and Announcements.

Step 3205 is choosing Program Option 1. The business uploads the banner or video advertisement from the local machine. The business initiate the request on the client's side. The server process starts the query. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the business to create the video advertisement by using the production tools and templates which include the steps to produce, edit, preview and post.

If the business select Program Option 2 (Step 3210), the business will create image advertisement by using the online design tools. The design tools include the templates, background colors, patterns, editor and canvas. Program Option 2 is developed by Java. Java programs can be procedures, functions, triggers, or packages. The process developed will help the business to finish creating and posting the banner advertisement. The stored procedure is a procedure or function which consists of a set of java constructs. Procedures and functions are identical except that functions always return a single value to the caller, whereas the procedures do not. The trigger is a java program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include procedures and functions that are callable only from inside of the package. The functionality of a package is similar to that of stored procedures.

When Step 3205 and 3210 are done, the data will be generated (Step 3215). The generated data needs to be verified (Step 3220). If the verification raises an exception, the data becomes invalid. The process needs to be back to Step 3205 and 3210 by taking Step 3225 and Step 3230. After the verification is done, the data will be saved in the database (Step 3235).

Step 3240 is making payment online. The collected information needs to be verified (Step 3245). If it is invalid, the process will go back to Step 3240 until the valid information is provided through Step 3250. The data will be submitted and saved in the database (Step 3255). The advertisement will be displayed (Step 3260).

The business will be notified to renew the service (Step 3265). The business have two options. The first option is ignoring it, and the advertisement will be taken off (Step 3270). The second option is renewing (Step 3275). The business need to make the payment online before any data will be saved in the database on the server (Step 3280). A new process will begin when the advertisement continues (Step 3285).

Route 3300 leads the business to creating advertisement in VIP Ads Showroom at the sixth level. Step 3305 is creating the front cover page. The front cover page will either be in the video or image format. The tools include the templates, editor, background colors, patterns, and canvas. The business can create the front cover page either by using the online design tools or upload the front cover page from the local machine. Step 3310 is creating the text and video advertisement content. The business type the text advertisement content in the block. The video advertisement needs to be uploaded. The text and video advertisement need to be verified before they are submitted. Step 3315 is designing and posting online image advertisement. The business will use the tools to post the image advertisement. The tools include the templates, background colors, patterns, editor and canvas. The generated data needs to be verified (Step 3020). If the data is invalid, the process will go back to the previous steps until the valid data is provided (Step 3025). If the data is valid, it will be saved (Step 3030).

Step 3335 is making payment online. Payment information needs to be collected. The collected information needs to be verified (Step 3340). If the information is invalid, the process will go back until the valid information is provided (Step 3345). The verified data will be submitted and saved in the database (Step 3350). The results will be shown (Step 3355). The results refer to all the advertisement content built for VIP Ads Showroom is successfully created.

The business is notified to renew the service (Step 3360). The business have two options before the process ends. The first choice is ignoring it and the service will stop when it expires (Step 3365). The second choice is renewing (Step 3370). After the information is updated (Step 3375), the data will be saved in the database (Step 3380). A new process will begin after the payment is made (Step 3385).

FIG. 7 (b) is a process flow diagram illustrating how advertisement is developed at the sixth level. Route 3400 leads the business to Products Shown on TV. Step 3405 is uploading the video advertisement from the local machine. The business initiate the request on the client's side. The server process starts the query. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the business to create the video advertisement by using the production tools and templates which include the steps of produce, edit, preview and post.

After the file is fetched, it will be previewed and verified (Step 3410). If the verification raises an exception, the process needs to be back to Step 3405 until the valid data is provided (Step 3415). The data will be saved in the database on the server after the verification is done (Step 3420). The next step is making payment online (Step 3425). The collected payment information needs to be verified (Step 3430). If the payment information is valid, it will be submitted and saved (Step 3435). If the information is invalid, the process will go back to Step 3425 through Step 3440 until the valid information is provided. The video will be displayed (Step 3445).

A notification will be sent to remind the business to renew the service (Step 3450). The business have two options before the process ends. The first choice is ignoring it and the service will stop when the service expires (Step 3455). The second choice is renewing (Step 3460). After the information is updated, the data will be saved in the database (Step 3465). A new process will begin after the payment is made (Step 3470).

Route 3500 leads to Service Group 3. Service Group 3 includes Monthly Ads Catalog, Quarterly Products Brochure, Coupons, Coupon Books, Export Products, and Import Products. Program Option 1A and 2A (Step 3505 and 3510) are uploading the front cover page and the catalog from the local machine. The business originate the request as user process. The server parses the request. There are three main stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. After the file is fetched, it will be previewed.

Option 1B and 2B (Step 3515 and 3520) are creating the front page and catalog by using the online design tools. The business use the online design tools and follow each process step before any data will be generated. The tools include templates, background colors, patterns, editor and canvas. After each step is taken, the data will be generated (Step 3525). The generated data needs to be verified (Step 3530). If the data is invalid, the process needs to be back until the valid data is provided through Step 3535. After the verification is done, the server will record the data and write it to the data blocks in the data files from database buffer cache (Step 3540). Step 3545 is to make payment online. Payment information will be collected. The collected information needs to be verified (Step 3550). If it is invalid, the process will go back to Step 3545 until the valid data is provided (Step 3555). The verified data will be submitted and saved in the database (Step 3560). The catalogs will be shown after the payment (Step 3565).

The business will be notified to renew the service (Step 3570). The business have two options before the process ends. The first choice is ignoring it and the service will stop when it expires (Step 3575). The second choice is renewing (Step 3580). After the information is updated (Step 3585), the data will be saved in the database (Step 3590). A new process will begin after the payment is made (Step 3595).

Route 3600 is related to Service Group 4. Service Group 4 includes Office Space & Suites and Warehouses & Distribution Centers. The business choose an area (Step 3605). An area can be a city or a metro area in a state. The next Step 3610 is to upload the banner or video advertisement from the local machine. The business initiate the request on the client's side. The server process starts the query. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 provides the solution for the business to post the video advertisement by using the production tools and templates which include the steps to produce, edit, preview and submit.

If the business take Step 3615, the business will create the image advertisement by using the online design tools. The business follow the steps developed by the programs. The programs are stored units. They can be procedures, functions, triggers, or packages. The process developed will help the business to finish creating and posting the banner advertisement. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include procedures and functions that are callable only from inside of the package. The functionality of a package is similar to that of stored procedures.

When Step 3610 and 3615 are done, the data will be generated (Step 3620). The generated data needs to be verified (Step 3625). If the verification raises an exception, the process will go back to Step 3610 and 3615 through Step 3630 and 3635. After the verification is done, the data will be saved in the database (Step 3640).

Step 3645 is making payment online. Payment information will be collected. The collected information needs to be verified (3650). If it is invalid, the process will go back to Step 3645 until the valid information is provided through Step 3655. The data will be submitted and saved in the database on the server after the verification (Step 3660). The advertisement will be displayed (Step 3665).

The business will be notified to renew the service (Step 3670). The business have two options before the process ends. The first choice is ignoring it and the service will stop when it expires (Step 3675). The second choice is renewing (Step 3680). After the information is updated (Step 3685), the data will be saved in the database on the server (Step 3690). A new process will begin after the payment is made (Step 3695).

FIG. 7 (c) is a process flow diagram illustrating how advertisement is developed at the sixth level. Route 3700 leads the business to Expose Business at the sixth level. Step 3705 is providing the information about the business. The next Step 3710 is selecting an industry and a location. A location is a designated area where the business choose to expose their business. Step 3715 is uploading the advertisement or any other material from the local machine. The business initiate the request on the client's side. The server process starts the query. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Route 3700 provides the option for the business to create the video advertisement by using the production tools and templates which include the steps of produce, edit, preview and post.

If the business take Step 3720, the business will create image advertisement by using the online design tools. The design tools include the templates, background colors, patterns, editor and canvas. There are program units stored on the server to perform specific tasks. They can be procedures, functions, triggers, or packages. The process developed will help the business to finish creating and posting the advertisement or other materials. Other materials can be introduction and promotion. The business follow each step before any data will be generated (Step 3725). The generated data needs to be verified (Step 3730). If the verification raises an exception, the data becomes invalid. The process needs to be back to the previous step until the valid data is provided (Step 3735 and 3740). After the verification is done, the server records the data and writes it to the data blocks in the data files from database buffer cache (Step 3745). Step 3750 is making payment online. The payment information will be collected. The collected information needs to be verified (Step 3755). If it is invalid, the process will go back to Step 3750 until the valid information is provided through Step 3760. The verified data will be submitted and saved in the database on the server (Step 3765). The advertisement will be shown (Step 3770).

The business will be notified to renew the service (Step 3775). The business have two options before the process ends. The first choice is ignoring it and the service will stop when it expires (Step 3780). The second choice is renewing (Step 3785). After the information is updated (Step 3790), the data will be saved in the database on the server (Step 3795). A new process will begin after the payment is made (Step 3795A).

Route 3800 leads the business to Market Tools. There are three options for Marketing Tools. Step 3805 (Program Option 1) is related to Service Group A. Service Group A can be introduction, advertisement or promotion for the business in either graphic or video format. The business need to choose whether to create the service by using the online design tools or upload the design work from the local machine. If the business choose to upload the design work from the local machine (Step 3810), a user process will be initiated on the client's side. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server.

If the business choose to use the online design tools (Step 3815), Program Option 2 will help the business finish the work. After the business follow each step, the data will be created (Step 3820). The generated data needs to be verified (Step 3825). If the data is invalid, the process needs to be back until the valid data is provided (Step 3830). The business choose the contacts (Step 3835) and send the content (Step 3840). If the data is valid, it will be saved in the database on the server (Step 3845). The process will end when the business picks another service or logs out (Step 3850).

Step 3855 (Program Option 3) is related to Service Group 2. Service Group 2 is designed for the business to build and keep relationship with their clients in text format. The business select a category in Service Group 2 and create content (Step 3860). After it is done, the data will be generated (Step 3865). The generated data needs to be verified (Step 3870). If the data is invalid, the process needs to be back to Step 3860 until the valid data is provided (Step 3875). The business need to select their business contacts (Step 3880) and send the content (Step 3885). Execute refers to the service content is sent out. The data will be saved and stored in the database for future use (Step 3890). The process will end when the business pick another service or logs out (Step 3895).

Route 3900 leads the business to Authorized Agents. The business need to provide the business information (Step 3905). The generated information will be verified (Step 3910). If the data is incorrect, the process needs to be back to the previous step until the valid data is provided (Step 3915). If it is correct, the data will be saved in the account (Step 3920). The process will end when the business pick another service (Step 3925).

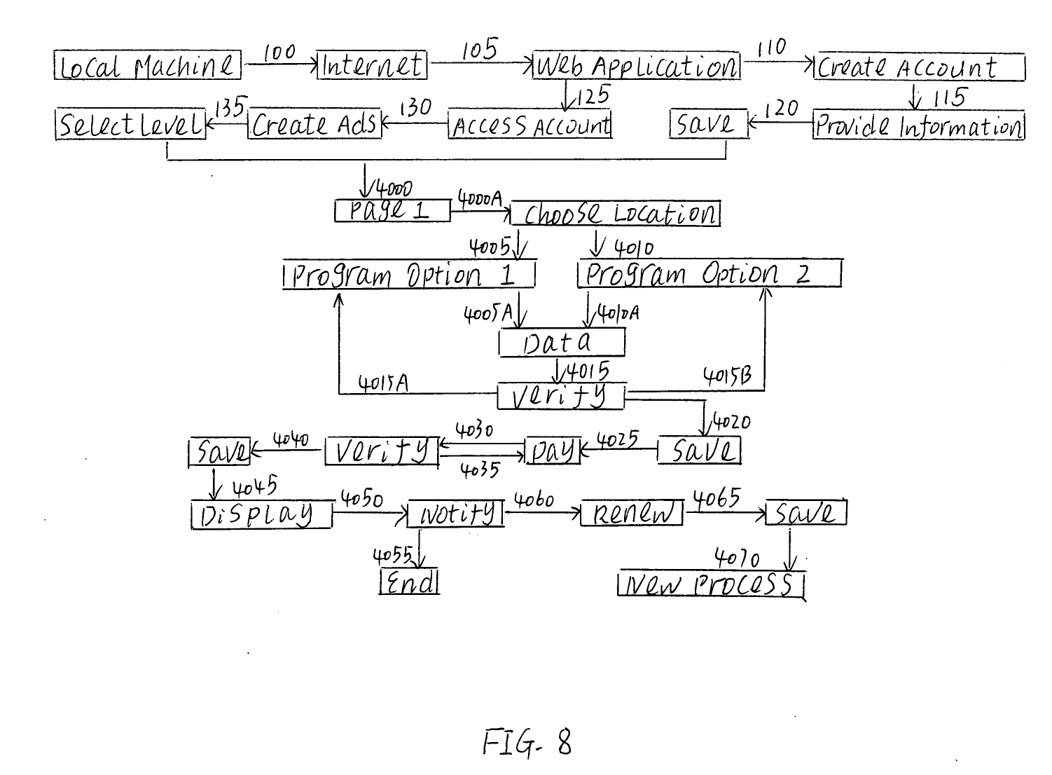

FIG. 8 is the process flow diagram illustrating how video and banner advertisement are developed at the seventh level. The seventh level is also the first industrial level. It consists of banner and video advertisement locations on the web page. The business connect to the web server through the interne (Step 100). The connection is a communication pathway between the user and the server process. A process created on the client's side is called the user process. The business originate the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page is made up of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the seventh level (Step 135).

Route 4000 leads the business to the first page of seventh level and choose a location (Step 4000A). The business choose either to take Step 4005 or Step 4010. Step 4010 (Program Option 2) contains the tools and process steps to create the banner advertisement. The tools include the templates, background colors, patterns, canvas and editor. The steps are developed to help the business finish posting the advertisement. The business pick a template, choose the background color from the galleries, select a canvas and a pattern, and use the editor. The business follow each step before getting the result. The result refers to the advertisement that is successfully created and posted.

If the business choose to take Step 4005 (Program Option 1), the business initiate the request. Program Option 1 is developed to help the business upload the design work from the local machine. The server process parses the request and locates where the advertisement is on the local machine. If the query is successful, it returns data as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. The fetched file data will be previewed.

The data generated from Step 4005 and Step 4010 (Step 4005A and 4010A) needs to be verified (Step 4015). If the data is invalid, the process will go back to Step 4005 or Step 4010 until the valid data is provided (Step 4015A and 4015B). If the data is valid, the server records the data and writes it to the data blocks in the database from database buffer cache (Step 4020). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity. If the data is invalid, the process needs to be back to Step 4005 and 4010 until the valid data is provided (Step 4015A and 4015B).

The next step is making payment and collect information (Step 4025). The collected payment information needs to be verified (Step 4030). If the information is invalid, the process will go back until the valid information is provided by taking Step 4035. If the data is valid, it will be submitted and saved in the database (Step 4040). The result will be shown (Step 4045). The result refers to the advertisement that is successfully created and posted.

The business will be notified to renew (Step 4050). The business have two options before the process ends. The first choice is ignoring it and the advertisement will be taken off when it expires (Step 4055). The second choice is renewing (Step 4060). After the information is updated, the data will be saved in the database (Step 4065). A new process will begin after the payment is made (Step 4070).

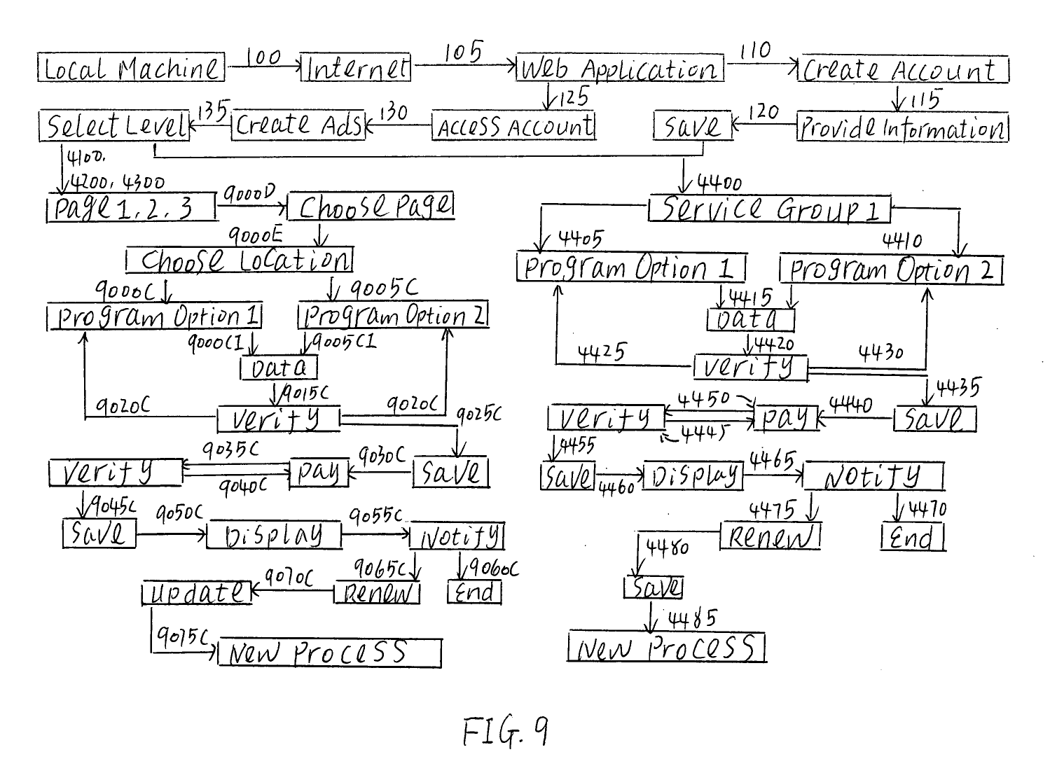

FIG. 9 is the process flow diagram illustrating how advertisement is developed at the eighth level. The eighth level is also the second industrial level. The business connect to the web server through the internet (Step 100). The connection is a communication pathway between the user and the server process. A process created on the client's side is called the user process. The business originate the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page is made up of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the eighth level (Step 135).

Route 4100, 4200 and 4300 lead to Page 1, Page 2 and Page 3 at the eighth level. There are banner and video advertisement locations on each page. Step 9000D is choosing a page. Step 9000E is choosing a location. The business choose either to take Step 9000C or the Step 9005C. Step 9005C (Program Option 2) contains the tools and process steps to create the banner advertisement. The tools include the templates, background colors, patterns, canvas and editor. The steps are developed to help the business finish creating the advertisement. The business pick a template, choose the background color from the galleries, select a canvas and a pattern, and use the editor. The business follow each step before getting the result. The result refers to the advertisement that is successfully created and posted.

If the business choose to take Step 9000C (Program Option 1), the business initiate the request. Program Option 1 is developed to help the business upload the design work from the local machine. The server process parses the request and locates where the advertisement is on the local machine. If the query is successful, it returns data as result. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. The fetched file will be previewed.

The data generated from Step 9000C and Step 9005C (Step 9000C1 and Step 9005C1) needs to be verified (Step 9015C). If the verification raises an exception, the data becomes invalid. The process needs go back to Step 9000C or Step 9005C until the valid data is provided (Step 9020C). If the data is valid the server records the data and writes it to the data blocks in the database from database buffer cache (Step 9025C). The purpose of a database is to store and retrieve related information. The database has a logical and physical structure. The physical structure of the database is the set of operating system files in the database. The database consists of A). Data files: Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files: Redo logs contain a record of changes made to the database to enable recovery of the data in case of failures. C). Control files: Control files contain information necessary to maintain and verify database integrity.

The next step is making payment and collecting information (Step 9030C). The collected payment information needs to be verified (Step 9035C). If the information is invalid, the process will go back until the valid information is provided by taking Step 9040C. If the data is valid, it will be submitted and saved in the database (Step 9045C). The result will be shown (Step 9050C). The result refers to the advertisement that is successfully created and posted.

The business will be notified to renew the service (Step 9055C). The business have two options before the process ends. The first choice is ignoring it and the advertisement will be taken off when it expires (Step 9060C). The second choice is renewing (Step 9065C). After the information is updated, the data will be saved in the database (Step 9070C). A new process will begin after the payment is made (Step 9075C).

Route 4400 leads the business to Service Group 1 is at the eighth level. Service Group 1 includes Aftermarket parts, Aftermarket products, Wholesale to All, On Sale, Special Deals, Clearance, Closeouts, Access Inventory, Liquidation Sales, Discount Products, Fresh Produce, Raw Materials, OEM Parts, OEM Products, Refurbished Products, Products & Services Promotion, Business Opportunities, Auctions, and Announcements.

Step 4405 is choosing Program Option 1. Program Option 1 is the process developed to help the business to upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the user to create the video advertisement by using the production tools and templates which include the steps to produce, edit, preview and post. After the video advertisement is uploaded or produced, the data will be saved on the server.

The business choose Program Option 2 (Step 4410). Program Option 2 is creating the image advertisement by using the online tools. The business use the design tools and follow each step to create and post the banner advertisement. The design tools include the templates, background colors, patterns, editor and canvas. The process steps are developed by Java. The developed programs can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package. B). The body implements the specification. It includes the compiled codes to implement the procedure and function specification included in the package specification. It may also include the procedures and functions that are callable only from inside of the package. The functionality of a package is similar to that of stored procedures.

After Step 4405 and Step 4410 are done, the data will be generated (Step 4415). The generated data needs to be verified (Step 4420). If the verification raises an exception, the process needs to be back to Step 4405 and 4410 by taking the Step 4425 and Step 4430. After the verification is done, the data will be saved in the database (Step 4435). The next step is making payment and collecting information (Step 4440). The collected information needs to be verified (4445). If the data is invalid, the process will go back to Step 4440 until the valid data is provided (Step 4450). The data will be submitted and saved in the database (Step 4455). The advertisement will be shown (Step 4460).

The business will be notified to renew the service (Step 4465). The business have two options before the process ends. The first choice is ignoring it and the service will stop when it expires (Step 4470). The second choice is renewing (Step 4475). After the information is updated, the data will be saved in the database (Step 4480). A new process will begin after the payment is made (Step 4485).

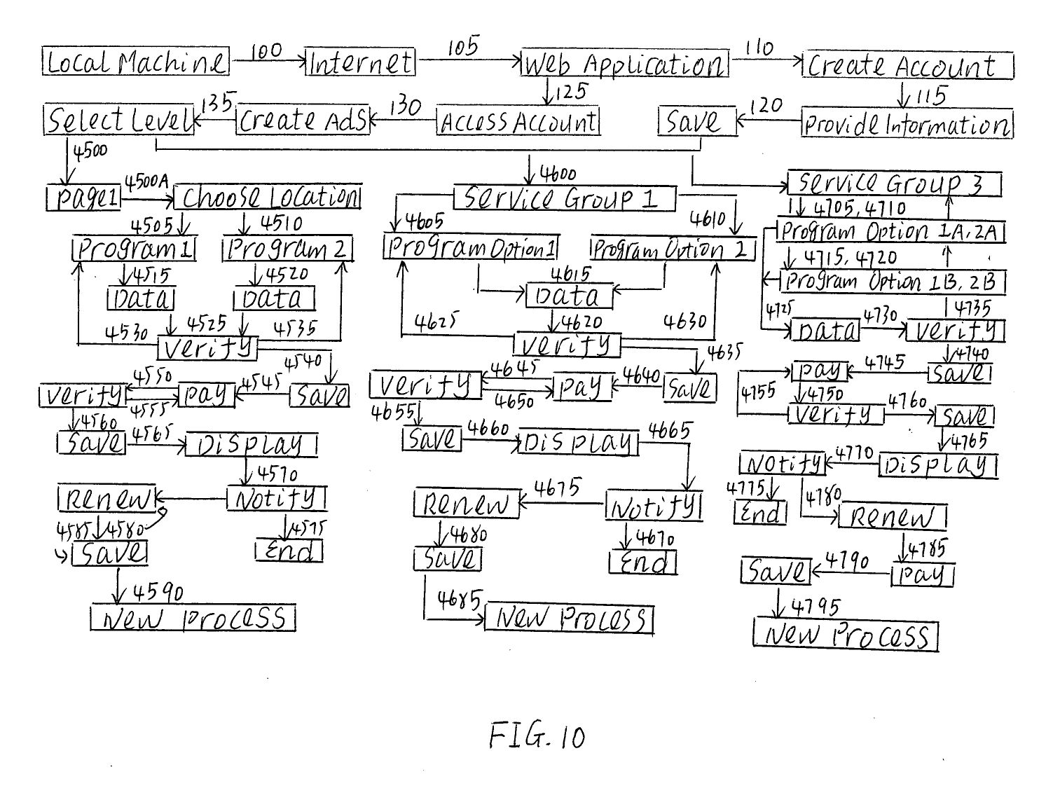

FIG. 10 is a process flow diagram illustrating how video and banner advertisement are created on the first page at the ninth level. The ninth level is also the industrial business listing level. The business connect to the web server through the internet (Step 100). The connection is a communication pathway between the user and server process. A process created on the client's side is called the user process. The business originate the request. The server listens, receives, parses and executes the request sent from the user process. This process is called the server process. The server process communicates with the server on behalf of the user process. The server process executes the request and sends the result back to the user.

The web application displays the graphic interface which is the first page of the website (Step 105). The interface of the first page consists of items. Items are used to present information from the database or to act as a control. The web application is event-driven. If an event occurs, the application responds to it. An event is either an interface event, which corresponds to a user's action, or an internal process event, which corresponds to a system action. Step 105 provides the option for the business to create an account (Step 110). If the business choose to create an account, the business are required to provide information (Step 115). The information includes the business name, address, location, contact person, phone number, email, username and password. There are two types of accounts. One is for regular user. The other is for business. After the information is provided and verified, the account will be created and the information will be saved on the server (Step 120). If the business have accounts, they can skip to create account and access to their account directly (Step 125). From there the business choose the category of post advertisement and select either banner or video (Step 130), and select the ninth level (Step 135).

Route 4500 leads the business to the first page at the ninth level. Step 4500A is choosing a location. The business choose either Step 4505 or Step 4510. Step 4510 (Program Option 2) contains the tools and process steps to create the banner advertisement. The tools include the templates, background colors, patterns, canvas and editor. The steps are developed to help the business finish creating the advertisement. The business need to pick a template, choose the background color from the gallery, select a canvas and a pattern, and use the editor. The business follow each step before getting the result (Step 4520). The result refers to the advertisement that is successfully created and posted. If the business choose to take Step 4505 (Program Option 1), the business initiate the request. Program Option 1 is developed to help the business upload the design work from the local machine. The server process parses the request and locates where the advertisement is on the local machine. After it is fetched, it will be generated (Step 4515)

The data generated from Step 4515 and Step 4520 needs to be verified (Step 4525). If the verification raises an exception, the data becomes invalid, the process will go back to the previous steps through Step 4530 or Step 4535 until the valid data is provided. If the data is valid, the server records the data and writes it to the data blocks in the database from database buffer cache (Step 4540)

The next step is making payment and collecting information (Step 4545). The collected payment information needs to be verified (Step 4550). If the information is invalid, the process will go back until the valid information is provided by taking Step 4555. If the data is valid, it will be submitted and saved in the database (Step 4560). The result will be shown (Step 4565). The result refers to the advertisement that is successfully created and posted.

The business will be notified to renew the service (Step 4570). The business have two options before the process ends. The first choice is ignoring it and the advertisement will be taken off when it expires (Step 4575). The second choice is renewing (Step 4580). After the information is updated, the data will be saved in the database (Step 4580). A new process will begin after the payment is made (Step 4585).

Route 4600 leads the business to Service Group 1 at the ninth level (the industrial business listing level). The service Group 1 includes On Sale, Special Deals, Overstock, Clearance, and Closeouts. The business choose Step 4605 (Program Option 1). Program Option 1 is the process developed to help the business upload the video advertisement from the local machine. The business initiate the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. Program Option 1 has the option for the business to create the video advertisement by using the production tools and templates which include the steps to produce, edit, preview and post. After the video advertisement is uploaded or produced, the data will be saved on the server.

The business choose Program Option 2 (Step 4610). Program Option 2 is creating the image advertisement by using the online tools. The business need to use the design tools and follow each step to create and post the banner advertisement. The design tools include the templates, background colors, patterns, editor and canvas. The process steps are developed by Java. The developed programs can be procedures, functions, triggers, or packages and are created and stored in the data dictionary as a schema object. The stored procedure is a procedure or function which consists of a set of java constructs. Procedures and functions are identical except that functions always return a single value to the caller, whereas the procedures do not. The trigger is a program unit that is executed implicitly by the server when a specific type of event occurs. The trigger is never called, it only executes when the event occurs. A package is a group of functionally related variables, constraints, cursors, exceptions, procedures, and functions stored together in the database for the as a unit. Packaged procedures and functions can be called explicitly by the applications or users. The package usually has two parts stored separately in the database: A). The specification is the interface to the application and declares the types, variables, constraints, exceptions, cursors, and subprograms available for use outside of the package, B). The body implements the specification. It includes the compiled codes to implement the procedure and function specification included in the package specification. It may also include the procedures and functions that are callable only from inside of the package. The functionality of a package is similar to that of stored procedures.

After Step 4605 and 4610 are done, the data will be generated (Step 4615). The generated data needs to be verified (Step 4620). If the verification raises an exception, the data becomes invalid, the process needs to be back to Step 4605 and 4610 by taking Step 4625 and Step 4630. After the verification is done, the data will be saved in the database (Step 4635). The next step is making payment and collecting information (Step 4640). The collected information needs to be verified (4645). If it is invalid, the process will go back to Step 4640 until the valid data is provided (Step 4650). The data will be submitted and saved in the database (Step 4655). The advertisement will be shown (Step 4660).

The business is notified to renew the service (Step 4665). The business have two options before the process ends. The first choice is ignoring it and the service will stop when it expires (Step 4670). The second choice is renewing (Step 4675). After the information is updated, the data will be saved in the database (Step 4680). A new process will begin after the payment is made (Step 4685).

Route 4700 leads the business to Service Group 3. Service Group 3 includes Coupons and Coupon Books at the ninth level. Program Option 1A and 2A (Step 4705 and 4710) are uploading the front cover page and the catalog from the local machine. The business originate the request. The request is sent as the user process. The server parses the request. There are three stages in the process A). In parse, the request is passed from the user process, and a parsed representation of the request is loaded into the local computer. During the parse, the server process searches for the existing request copy of the request in the local computer, validates the request by checking its syntax, performs data dictionary lookups to validate file definitions, acquires parse locks on the object so that the definition doesn't change during the parsing of the request, checks the user's privileges to access the referenced schema object, determines the optimal execution plan for the request, loads the request and execution plan into the buffer cache and sends back to the server for processing. The parse stage includes processing the requirement that needs to be done only once. The server usually translates each requirement only once, re-executing what parsed during subsequent references to the request. Although parsing requirement validates that required, parsing only identifies errors that can be found before requirement execution. B). Executing the requirement, at this point, the local computer has all the resources and necessary information, so the requirement is executed. The user process prepares to retrieve the data. C). Fetching, in this stage, the file is selected and returned by the user to the server. After the file is fetched, it will be previewed.

Program Option 1B and 2B (Step 4715 and 4720) are creating the front page and catalog by using the online tools. The business use the online design tools and follow each process step before any data will be generated. The tools include templates, background colors, patterns, editor and canvas. After each step is taken, the data will be generated (Step 4725). The generated data needs to be verified (Step 4730). If the verification raises an exception, the process will go back until the valid data is provided through Step 4735. After the verification is done, the server will record the data and write them to the data blocks in the data files from database buffer cache (Step 4740).

Step 4745 is making payment. Payment information will be collected. The collected information needs to be verified (Step 4750). If it is invalid, the process goes back to Step 4745 until the valid data is provided (Step 4755). The verified data will be submitted and saved in the database on the server (Step 4760). The catalogs will be displayed after the payment (Step 4765).

The business will be notified to renew the service (Step 4770). The business have two options before the process ends. The first choice is ignoring it and the service will stop when it expires (Step 4775). The second choice is renewing (Step 4780). After the information is updated (Step 4785), the data will be saved in the database on the server (Step 4790). A new process will begin after the payment is made (Step 4795).

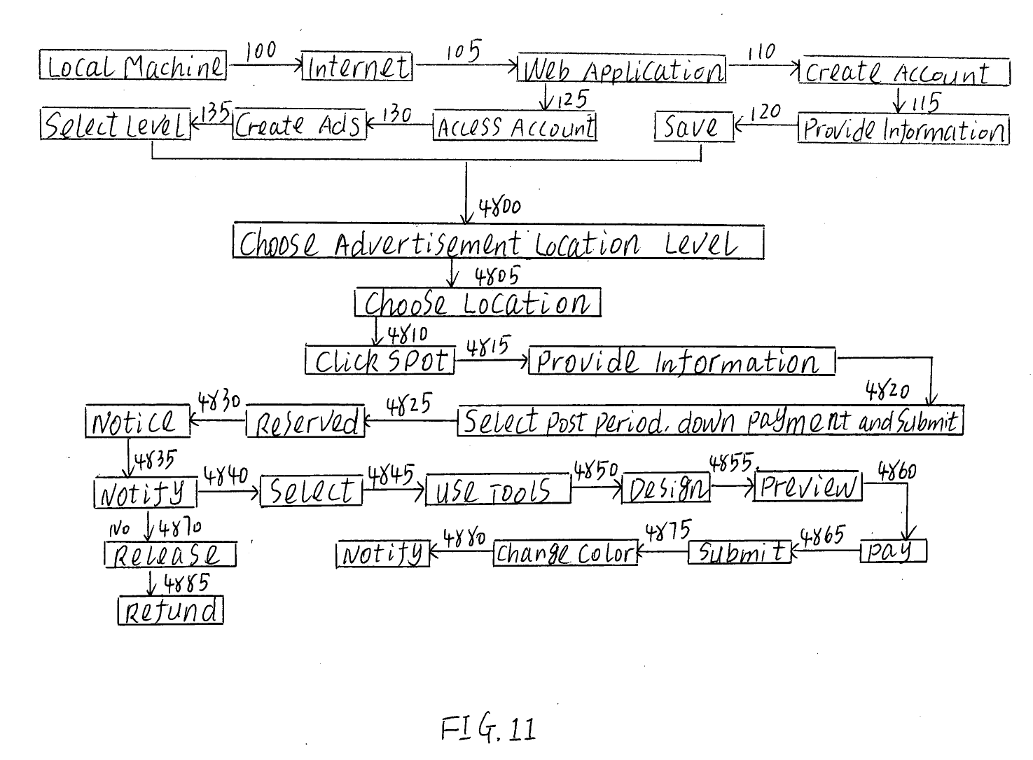

FIG. 11 is a process flow diagram illustrating how reservation is made at different levels. The business choose a level after accessing the website (Step 4800). Step 4805 is choosing an advertisement location. The advertisement location can be at any level. The advertising location needs to be occupied in order to be reserved. There is reminder of available for reservation shown on the location. The process begins with by clicking the red background color of the location (Step 4810). The business provide business contact information in the next step (Step 4815). The following steps to finish reservation include choosing the posting period, making down payment and submitting (Step 4820). After submission, the condition of the advertising location is locked and the color of the background turns into blue (Step 4825). A notice appears on the advertising location indicating that the location is reserved and can be bid (Step 4830). The business will be notified when the advertising location is available if there is no bid (4835). The business follow the steps which include 1. Selecting the advertisement location (Step 4840), 2. Using the design tools (Step 4845), 3. Designing the advertisement (Step 4850), 4. Previewing (Step 4855) Making online payment (Step 4860), and 5. Submitting (Step 4865). If the business ignore the notification, the reserved spot will be released (Step 4870). The color of the background of the advertising location changes back to red (Step 4875). If there is bid, the business will be notified (Step 4880). The business will get refund if the business fail to reserve the advertisement location (Step 4885).

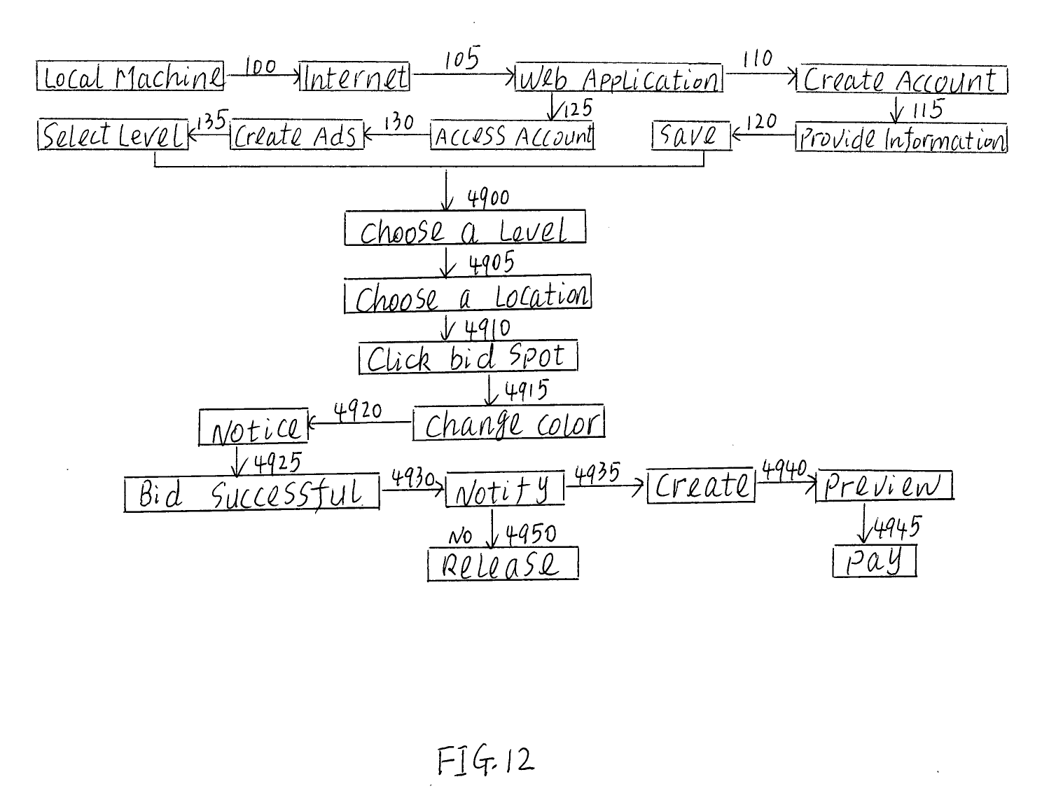

FIG. 12 is a process flow diagram illustrating how bid is made at different levels. The business choose a level after accessing the website (Step 4900). Step 4905 is choosing an advertisement location. The advertisement location can be at any level. The advertising location cursor points on the scrolling advertisement, and text advertisement automatically taken off from the webpage when it expires, advertisement location reservation, bid and auction. The compiled programs are saved on the server. They will be initiated when they are triggered.

The steps described represent the method developed for online advertisement self-creation. The method includes nine different levels. There are text, banner and video advertisement locations and categories that are built within the web application. The business can design, create and post advertisement online by following the instructions. It should be understood that certain changes could affect the method within the scope of the invention.

1: A method for online national and local advertisement self-creation comprising the following steps:
logging on to the internet;
assessing the service provider's website;
creating an account;
selecting a level;
selecting advertisement format;
choosing an advertisement location or a service;
designing text, banner or video advertisement;
uploading advertisement content;
choosing posting period;
previewing the created advertisement;
making online payment;
and submitting.

2. The method of claim 1, further comprising text, banner and video creation tools, wherein the tools include advertisement design and creation area, word editor, templates, backgrounds, and textures.

3. The method of claim 1, further comprising two separated modules and nine different levels, wherein the two modules are commercial and industrial module; and the nine levels are national, state, metro area, city, business listing, national industry, first industrial, second industrial and industrial business listing level.

4. The method of claim 1, further comprising advertisement categories, wherein commercial advertisement categories include wholesale to all, on sale, special deal, clearance, closeout, overstock, tent event, new and unique products, gift ideas, hot product, discount products, product & service promotion, business opportunity, finance/investment, franchises, events, workshop/seminar, auctions, announcements, weekly ads, monthly ads catalog, quarterly products brochure, coupons and coupon books, export products, liquidation sale, trade shows/conventions, office space and suite, products shown on TV, travel, VIP advertisement showroom, export products, import products, and warehouse & distribution center; and industrial advertisement categories include aftermarket parts, aftermarket products, wholesale to all, on sale, special deal, clearance, closeout, access Inventory, liquidation sale, tent events, new & unique products, discount products, fresh produce, raw materials, OEM parts, OEM products, quality products, hot products, refurbished products, product & service promotion, business opportunity, finance/investment, franchises, events, trade show/convention, workshops-seminars, auctions, and announcements.

5. The method of claim 1, wherein advertisement can be taken off the location automatically when it is expired.

6. The method of claim 1, wherein advertisement locations can be built on the webpages.

7. The method of claim 1, wherein the business create advertisement in their account.

8. The method of claim 1, wherein the background color can be changed in the creation area after the creation of the advertisement for the web page's location is done.

9. The method of claim 1, further comprising notice shown on the screen in the business' account when they check advertisement locations, wherein the notice includes posting period and when the advertisement location will be available.

10. The method of claim 1, wherein the advertisement location on the web page can be reserved.

11. The method of claim 1, wherein the advertisement location on the web page can be bid.

12. The method of claim 1, wherein the advertisement location on the web page can be auctioned.

13. The method of claim 1, wherein the background color changes after reservation, bid and auction are done.

14. The method of claim 1, wherein a notice is shown on the screen providing the status for reservation, bid and auction in the business account.

15. The method of claim 1, further comprising authorized advertisement dealers.

16. The method of claim 1, further comprising membership.

17. The method of claim 1, wherein created advertisement are saved and can be retrieved for editing and using again.

18. The method of claim 1, further comprising marketing tools, wherein marketing tools are used to launch campaign and maintain customer relationship.

19. The method of claim 1, further comprising advertising modules created for the Asians, Mexicans, and Europeans.

20. The method of claim 1, wherein text, banner and video advertisement can be self-created and embedded when the business create online stores.
